(19) United States
(12) Patent Application Publication
(10) Pub. No.: US 2026/0288724 A1
(43) Pub. Date: Sep. 24, 2026

(54) SYSTEM

(71) Applicant: SoftBank Group Corp., Tokyo (JP)

(72) Inventor: Natsumi MIYAZAKI, Tokyo (JP)

(73) Assignee: SoftBank Group Corp., Tokyo (JP)

(21) Appl. No.: 19/567,336

(22) Filed: Mar. 16, 2026

(30) Foreign Application Priority Data
Mar. 19, 2025 (JP) 2025-045167

(51) Int. Cl. G06F 16/2453; G06F 16/583; G10L 25/63

(52) U.S. Cl. CPC G06F 16/24542; G06F 16/583; G10L 25/63

(57) ABSTRACT

A system includes a processor that is configured to receive input from a user and, based on the input, store location information of an item in a database, analyze an inquiry from the user by using a natural language processing technique, search for corresponding location information of the item, and provide the location information to the user, make a suggestion of a storage location for an item belonging to a same type as another item by referring to past storage history data, analyze an emotional state of the user by using an emotion engine that recognizes emotion of the user, and adjust provision of the location information of the item and the suggestion of the storage location based on the emotional state, and use a generative AI model and generate a prompt for instructing analysis of the inquiry from the user and generation of a response in natural language.

### CROSS-REFERENCE TO RELATED APPLICATION

This application is based on and claims priority under 35 USC 119 from Japanese Patent Application No. 2025-045167 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional item management systems and file management systems generally require a user to manually search for stored items or digital files based on static metadata or fixed folder structures. Such systems do not adequately support natural language interaction, and therefore a user must adapt to rigid command formats or keyword input, which reduces usability. In addition, conventional systems typically do not consider the emotional state of the user, and therefore cannot adjust responses or proposals in a manner that reduces user stress or frustration during search and storage operations. Furthermore, in many cases, the system does not provide intelligent suggestions for storage locations based on past storage history, and does not utilize advanced generative AI models to generate flexible, natural-language responses for both physical and digital item management. As a result, there is a need for a system that can, in an integrated manner, store and retrieve item location information for physical and digital items, understand and respond to user inquiries formulated in natural language, propose suitable storage locations based on past usage, and adapt the style and content of responses in accordance with the emotional state of the user, by leveraging an emotion recognition engine and a generative AI model.

### SUMMARY

In order to solve the above-described problems, a system according to at least one embodiment of the present invention comprises a processor. The processor is configured to receive input from a user and, based on the input, store location information of an item in a database. The processor is further configured to analyze an inquiry from the user by using a natural language processing technique, search for corresponding location information of the item, and provide the location information to the user. The processor is also configured to make a suggestion of a storage location for an item belonging to the same type as another item by referring to past storage history data. Moreover, the processor is configured to analyze an emotional state of the user by using an emotion engine that recognizes emotion of the user, and adjust provision of the location information of the item and the suggestion of the storage location based on the emotional state. In addition, the processor is configured to use a generative AI model and generate a prompt for instructing analysis of the inquiry from the user and generation of a response in natural language. In certain embodiments, the processor is further configured to store the location information of the item in a database that includes at least one of a physical location and a digital storage location, and to generate, based on past storage location information and the emotional state of the user, a prompt for instructing the generative AI model to make a suggestion, and to make the suggestion based on the prompt.

The term “system” refers to a combination of hardware and software components including at least one processor configured to execute the functions recited in the claims.

The term “processor” refers to any computing element, such as a CPU, GPU, microprocessor, microcontroller, or a logical processing unit implemented in hardware, firmware, or a combination thereof, that is configured to execute instructions to perform the claimed functions.

The term “user” refers to a human operator who interacts with the system by providing inputs and inquiries and receiving responses and suggestions from the system.

The term “input” refers to any data, command, or information provided by the user to the system, including but not limited to item names, locations, categories, inquiries, and other parameters used for storage or retrieval operations.

The term “item” refers to an object or data entity whose location information is managed by the system, including but not limited to physical goods and digital files.

The term “location information” refers to data that identifies where an item is stored, including information representing a physical storage place or a digital storage location.

The term “database” refers to any structured or unstructured data storage facility, implemented in volatile or non-volatile memory, that stores location information and other related information accessible by the processor.

The term “natural language processing technique” refers to any algorithm, model, or method that enables the system to analyze, interpret, or understand text or speech expressed in a human language.

The term “inquiry” refers to a request expressed by the user, in natural language or other form, for information regarding an item, including but not limited to a request for the location information of the item or a storage suggestion.

The term “storage history data” refers to past records maintained by the system indicating how and where items, including items of the same type or category, have been stored over time.

The term “same type” refers to items that belong to a common class, category, or group determined by the system or specified by the user, such as similar functions, attributes, or usage contexts.

The term “storage location” refers to a place or position where an item is stored, including locations for physical items and paths or addresses for digital items.

The term “emotion engine” refers to a software and/or hardware module configured to recognize, estimate, or infer an emotional state of the user based on input signals, which may include text, voice, facial expressions, biometric data, or interaction patterns.

The term “emotional state” refers to a state representing the user's emotion, such as stress, frustration, satisfaction, calmness, or other affective conditions, as recognized or inferred by the emotion engine.

The term “adjust provision” refers to modifying one or more aspects of the system's response, including wording, tone, level of detail, content selection, or timing, based on the emotional state of the user.

The term “generative AI model” refers to an artificial intelligence model, such as a large language model or other generative model, that is capable of generating natural-language text or other content in response to input instructions or prompts.

The term “prompt” refers to a structured instruction, message, or input sequence provided to the generative AI model to control or guide analysis of the user's inquiry and generation of a natural-language response or suggestion.

The term “digital storage location” refers to a logical or physical address in a digital environment where a digital item is stored, including but not limited to file system paths, URLs, cloud storage paths, database entries, or other digital resource identifiers.

The term “physical location” refers to a real-world place where a physical item is stored, such as a room, drawer, shelf, box, cabinet, or any other identifiable physical storage area.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

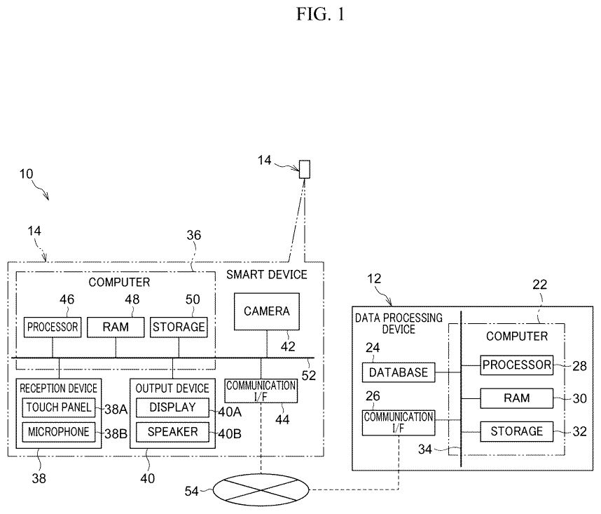

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

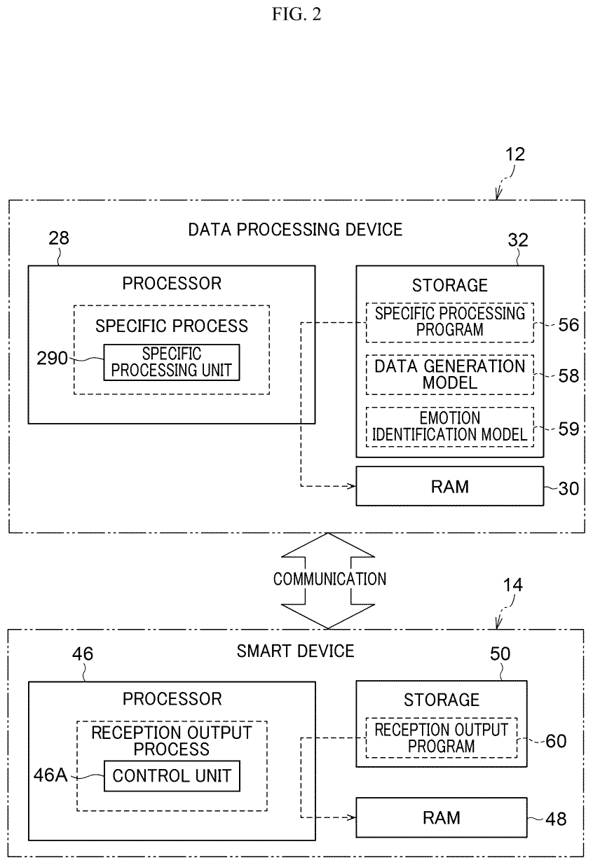

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional item management systems that record locations of physical or digital items generally rely on fixed keyword matching and static user interfaces. Such systems typically require that a user remember exact item names or predefined categories in order to retrieve stored location information. As a result, when a user submits a natural-language query that is vague, incomplete, colloquial, or emotionally charged, conventional systems often fail to correctly interpret the query, leading to search failures, irrelevant results, or the need for repeated user input. This degrades the usability and reliability of the underlying computer system, increases the computational overhead for repeated lookups, and provides no effective adaptation to user-specific context or emotional state.

Moreover, known systems that integrate machine learning or natural language processing usually treat the language model as a black-box component that only generates text, without systematic control over how prompts are constructed, how database search is coordinated, or how user emotion is reflected in generated responses. Such architectures do not fully exploit the capabilities of generative AI models and often produce responses that are inconsistent with stored data, overly verbose, or inappropriate in tone. This leads to inefficiencies in processing pipelines, unnecessary model calls, and difficulty in maintaining a predictable and verifiable data flow from user input through database lookup to final response generation.

In addition, existing solutions for suggesting storage locations for items generally use rule-based heuristics or simple frequency-based recommendations that are detached from real-time user interactions. These approaches are not designed to dynamically incorporate a user's historical storage behavior in combination with the current intent expressed in natural language, and they do not take into account the user's emotional state when presenting suggestions. Consequently, such systems cannot provide adaptive, context-aware proposals that are both technically efficient and user-appropriate, and they fail to improve the overall performance and human-computer interaction quality of the item management platform. A technical problem therefore exists in providing a computer-implemented system and method that: (i) tightly integrates a database management subsystem with a generative AI model through explicitly controlled prompt sentences; (ii) systematically extracts structured search keys from unstructured natural-language queries; (iii) coordinates database search and response generation in a deterministic and auditable manner; and (iv) adjusts the generation and presentation of answers and storage suggestions based on user-specific historical data and emotional state. The problem to be solved is to improve the functioning of the computer itself-namely, to enhance accuracy, efficiency, adaptability, and robustness of the end-to-end pipeline for registering, searching, and presenting item location information, by architecting the interaction between the processor, database, and generative AI model in a technically specific way.

The specific processing by the specific processing unit 290 of the data processing device 12 in Example 1 is realized by the following means.

The present invention provides a server comprising a processor configured to receive item identification information and storage location information from a user terminal and store, via a write operation to a database management program operating on a general-purpose information processing apparatus, the item identification information and the storage location information as location information indicating an association between an item and a storage location; to generate an analysis prompt sentence for presentation of a natural-language inquiry sentence, received from the user terminal, to a generative AI model having a natural language processing function, and to execute an inference operation of the generative AI model using the analysis prompt sentence so as to extract, from the inquiry sentence, keyword information or intent information for identifying the item; to execute a search operation on the database management program based on the extracted keyword information or intent information, and to acquire, as a search result, the location information stored in association with the item identification information; to generate a response-generation prompt sentence including the acquired location information and the inquiry sentence, to present the response-generation prompt sentence to the generative AI model so as to cause the generative AI model to generate a natural-language answer sentence consistent with the acquired location information, and to transmit the generated answer sentence to the user terminal; to derive, by arithmetic processing based on past storage history data, a candidate storage location for an item having the same or similar attribute as the item corresponding to the extracted keyword information or the item identification information, and to output, to the user terminal, proposal information including the candidate storage location; and to analyze a user emotional state from operation information or utterance information of a user by using an emotion analysis function, to generate control information for adjusting, according to the user emotional state, at least one of an expression content of the analysis prompt sentence, an expression content of the response-generation prompt sentence, and an expression content of the answer sentence, and to change, by using the control information, a presentation mode of an analysis result and an answer result produced by the generative AI model. This enables the server-centered computer system to transform unstructured natural-language queries into structured search keys, to coordinate deterministic database access with controlled generative AI output, and to adapt both storage-location answers and storage suggestions to user-specific history and emotional context, thereby improving the technical performance, reliability, and user interaction efficiency of the item location management platform.

The term “processor” refers to a hardware or virtual information processing unit, such as a central processing unit or a processing core of a computing apparatus, that is capable of executing instructions to perform arithmetic operations, control operations, and data input/output operations.

The term “user terminal” refers to an electronic apparatus operated by a user, such as a mobile communication device, a portable computing device, or a stationary computing device, that is configured to transmit input information to a server and to receive and display output information from the server.

The term “item identification information” refers to data that distinguishes an item from other items, including but not limited to an item name, a category label, an identifier, or a descriptive string that characterizes the item.

The term “storage location information” refers to data indicating a place at which an item is stored, including but not limited to information representing a physical storage location, a digital storage location, or a combination thereof.

The term “location information” refers to structured data representing an association between item identification information and storage location information, such that a storage place corresponding to a particular item can be retrieved by a search operation.

The term “database management program” refers to software executed by an information processing apparatus that manages creation, update, search, and deletion of data records in a storage device, and that provides an interface for performing operations such as write operations and search operations on a database.

The term “write operation” refers to a process by which the processor causes new data, or modified data, to be stored in a storage device under the control of the database management program.

The term “natural-language inquiry sentence” refers to a text string expressed in a human language that is provided by a user to request information regarding an item or a storage location.

The term “generative AI model” refers to a machine learning model configured to generate output data, including natural-language text, in response to input data, and that is capable of performing natural language processing such as understanding, analysis, and generation of sentences.

The term “natural language processing function” refers to a computational capability of analyzing, interpreting, or generating human-language text, including operations such as tokenization, part-of-speech tagging, semantic analysis, and response generation.

The term “analysis prompt sentence” refers to a control text provided to the generative AI model that specifies how the model is to analyze a natural-language inquiry sentence, and that is designed to cause the model to output keyword information or intent information for identifying an item.

The term “response-generation prompt sentence” refers to a control text provided to the generative AI model that includes at least the acquired location information and the natural-language inquiry sentence, and that instructs the model to generate a natural-language answer sentence consistent with the acquired location information.

The term “keyword information” refers to textual data extracted from a natural-language inquiry sentence that represents one or more terms used as search keys for identifying a corresponding item in the database.

The term “intent information” refers to structured or semi-structured data indicating the purpose, target, or meaning of a natural-language inquiry sentence, which can be used to identify an item or a type of request.

The term “search operation” refers to a process by which the processor issues a query to the database management program, based on keyword information or intent information, to retrieve records that satisfy predetermined conditions.

The term “search result” refers to data returned by the database management program in response to a search operation, including at least location information associated with item identification information.

The term “answer sentence” refers to a natural-language text generated by the generative AI model that provides a response to the natural-language inquiry sentence, including information about a storage location or a suggestion.

The term “past storage history data” refers to data representing historical associations between items and storage locations, including records of previous storage operations, retrieval operations, and user interactions related to item placement.

The term “candidate storage location” refers to a storage place derived by computation based on past storage history data and item attributes, which is proposed as a suitable location for storing an item.

The term “proposal information” refers to output data provided to the user terminal that includes at least one candidate storage location and optionally additional explanatory or contextual information for guiding item storage.

The term “operation information” refers to data indicating user interactions with the user terminal or the server, including but not limited to input patterns, selection operations, interaction sequences, and timing information.

The term “utterance information” refers to data obtained from user speech, including recognized text from voice input or acoustic features indicative of user speech content and tone.

The term “emotion analysis function” refers to a computational function, implemented by software or hardware, that determines a user emotional state based on at least one of operation information and utterance information, using rule-based, statistical, or machine learning techniques.

The term “user emotional state” refers to an estimated psychological or affective condition of a user, such as calmness, frustration, satisfaction, or urgency, inferred by the emotion analysis function.

The term “control information” refers to data generated by the processor that specifies how to adjust at least one of the expression content of the analysis prompt sentence, the expression content of the response-generation prompt sentence, and the expression content of the answer sentence, in accordance with the user emotional state.

The term “presentation mode” refers to a manner in which information, including analysis results and answer results produced by the generative AI model, is formatted, prioritized, or displayed to the user, such as tone, level of detail, or ordering of content.

The term “analysis result” refers to output data produced by the generative AI model in response to the analysis prompt sentence, including keyword information, intent information, or other structured data derived from a natural-language inquiry sentence.

The term “answer result” refers to output data produced by the generative AI model in response to the response-generation prompt sentence or a proposal prompt sentence, including one or more natural-language sentences to be presented to the user.

The term “general-purpose information processing apparatus” refers to a computing system, such as a server-class machine or a cloud computing node, that is not specialized to a single fixed function and that can execute multiple software programs including the database management program and application logic.

In one embodiment, a server cooperates with one or more terminals operated by a user to implement an item location management system that records, searches, and presents location information for physical or digital items. The server executes application software, a database management program, and a generative AI model interface on a general-purpose information processing apparatus, such as a rack-mounted server or a cloud computing node having at least one central processing unit, a main memory, a nonvolatile storage device, and a network interface. The terminal executes a user interface program on a computing device such as a smartphone, a tablet, or a personal computer, and communicates with the server via a packet-based communication network.

The server executes an operating system, such as a general-purpose server operating system, and an application framework, such as a web application framework or an application server, that provides an HTTP or HTTPS interface. The server executes a database management program, such as a relational database management system conforming to the SQL standard (for example, software of a type similar to a general-purpose relational database product such as a well-known open-source database or a commercial database), to manage tables that store item identification information and storage location information. The server also executes a generative AI model interface that communicates with a generative AI model deployed locally on a graphics processing unit or accessible through an external AI service.

The terminal executes a browser application or a native application framework (for example, a mobile application framework) and displays, on a display unit, input fields for an item name and a storage location, and an input field for a natural-language query. The terminal includes an input device such as a touch panel or keyboard and, in some embodiments, a microphone to capture utterance information. The terminal transmits user inputs to the server as structured messages over the network and receives responses from the server for display.

The user operates the terminal to input item identification information and storage location information. The terminal converts these inputs into a structured payload, including a user identifier, an item name, and a storage location description, and transmits the payload to the server using a communication protocol such as HTTPS. The server receives the payload, validates its syntax and semantics, and converts the item name and the storage location description into a normalized internal representation. The server causes the database management program to execute an insertion operation into a table that includes fields for a user identifier, an item identifier, a normalized item name, a normalized storage location string, and timestamps. The database management program stores the record in a persistent storage device and updates one or more indexes, for example an index on a composite key of the user identifier and the normalized item name.

The server configures the database schema such that storage location information can represent at least one of a physical location and a digital location. For example, the server stores a physical location as a hierarchical path (e.g., “house/bedroom/closet/left side”), and stores a digital location as a resource path (e.g., “cloud_storage/documents/receipts”).

The server uses structured columns for different levels of the hierarchy in order to enable efficient range queries and partial matches by the database management program. This structured data model improves search performance compared to flat string matching because the database engine can use B-tree or hash indexes on hierarchical segments.

When the user desires to locate an item, the user operates the terminal to input a natural-language inquiry sentence such as “Where is my winter coat?” or “Where are the stationery items I used last month?”. The terminal sends this inquiry to the server with the user identifier. The server receives the inquiry and initiates a natural language analysis sequence.

The server does not simply forward the inquiry to the generative AI model as-is; instead, the server constructs a specifically designed analysis prompt sentence that constrains the behavior of the generative AI model.

In one embodiment, the server generates an analysis prompt sentence such as:

“You are a natural language parser for an item-location system.

Input: a user question about where an item is stored.

Task: extract only the item name or names mentioned by the user.

Output: return only the item name or names, without any additional words.

User question: ‘Where is my winter coat?’”

The server transmits this analysis prompt sentence to the generative AI model together with model parameters such as a low temperature value and a maximum token limit that restricts the output length. The server uses a generative AI model implemented as a multi-layer neural network, for example a transformer-based architecture having a plurality of self-attention layers, feedforward layers, and layer normalization units. The model has been pre-trained on a large corpus of text data and optionally fine-tuned on a domain-specific dataset of item-related inquiries and labels. The model uses token embeddings, positional encodings, and multi-head attention mechanisms to process the input sequence of tokens that represent the analysis prompt sentence.

The server controls the generative AI model to behave deterministically by setting the temperature to a small value and disabling random sampling. This control reduces variance in extracted keywords and thus improves the reliability of downstream database operations. The generative AI model internally computes attention scores between tokens, propagates activations through layers, and generates output token probabilities, which the server decodes into text. The server then applies a post-processing pipeline: the server trims whitespace, converts text to a canonical case, removes punctuation, and, in some embodiments, enforces a simple pattern such as disallowing line breaks or non-alphanumeric characters. The server thereby obtains keyword information or intent information that can be directly used as a database search key.

In another embodiment, the server uses a constrained decoding rule for the generative AI model such that the model is restricted to output one of a limited set of known item categories stored in a category table. The server uses this rule to further stabilize the mapping between natural-language expressions and internal category identifiers, which improves search accuracy and reduces ambiguous mappings.

The server then uses the extracted keyword information to construct a query for the database management program. For example, the server generates an SQL query that uses normalized matching (e.g., case-insensitive comparison and removal of stop words) and, in some embodiments, uses a weighted similarity function between the extracted item name and stored item names. The server may calculate a similarity score based on n-gram overlap, edit distance, or vector-based similarity produced by a separate embedding model. The server conveys these parameters to the database layer using prepared statements or stored procedures, which in turn perform the matching operation using optimized index scans or full-text search mechanisms.

The server retrieves, from the database management program, location information associated with one or more candidate items matching the extracted keywords. The server optionally ranks the candidate items based on similarity scores, recency of storage, or usage frequency derived from past storage history data. The server then generates a response-generation prompt sentence that includes the original user inquiry and the resolved location information under explicit instructions to the generative AI model to respect the database result. For example, the server constructs a response-generation prompt sentence such as:

“You are an assistant for an item-location system.

The system has already searched its database and obtained the following result.

User question: ‘Where is my winter coat?’

Database result: ‘The winter coat is stored on the left side of the bedroom closet.’

Task: Answer the user in one short English sentence that is consistent with the database result.

Do not invent new locations.”

The server submits this response-generation prompt sentence to the same generative AI model or to a separate generative AI model instance, again under constrained decoding parameters. The generative AI model processes the prompt, internally attends to the portions labeled as “Database result,” and generates a natural-language answer sentence such as “Your winter coat is on the left side of the bedroom closet.” The server receives this answer sentence, performs final validation (for example, checking that the answer includes the main location phrase and does not contradict the database result), and transmits the answer sentence to the terminal. The terminal displays the answer sentence on the screen and optionally uses audio output to read the sentence aloud.

By constraining both the analysis prompt sentence and the response-generation prompt sentence, the server improves the technical functioning of the overall system. Specifically, the server reduces the number of database queries required to resolve an item, because the generative AI model outputs a more precise keyword. The server also reduces network traffic toward external AI services by eliminating retries caused by misinterpretation and by limiting token usage through carefully designed prompt sentences and decoding parameters.

Furthermore, by forcing consistency between model output and database results, the server prevents logically inconsistent answers that would otherwise reduce the reliability of the system.

In another embodiment, the server uses past storage history data to compute candidate storage locations for new or similar items. The server stores, in the database, historical records that associate item attributes (such as category, size group, or usage season) with storage locations that the user previously selected. The server calculates a feature vector for each historical record, including numerical encodings of item attributes and location attributes. The server uses an algorithm such as k-nearest neighbors, clustering, or a small neural network to compute similarity between a new item and historical items. The server then selects one or more candidate storage locations based on the most similar historical records.

The server generates proposal information that includes candidate storage locations and explanatory text. The server may use a proposal prompt sentence to cause the generative AI model to generate user-friendly suggestion sentences while preserving the set of candidate locations. For example, the server constructs a proposal prompt sentence such as:

“You are an assistant that suggests storage locations for items.

User item: ‘winter scarf’.

Candidate storage locations from history:
1. ‘top drawer of the bedroom dresser’
2. ‘right side of the bedroom closet shelf’

Task: Suggest to the user one or more suitable locations, rephrasing the candidate storage locations in natural English, without introducing locations not listed above.”

The server submits this proposal prompt sentence to the generative AI model and obtains a suggestion sentence such as “You can store your winter scarf in the top drawer of your bedroom dresser or on the right side of the bedroom closet shelf.” The server transmits this suggestion to the terminal for display. The explicit rule in the prompt that forbids the introduction of new locations ensures that the generative AI model does not create storage recommendations unrelated to historical data, thereby keeping the system's behavior auditable and technically grounded in the database.

The server additionally implements an emotion analysis function for adjusting prompt content and presentation mode according to a user emotional state. The server acquires operation information, such as input speed, frequency of corrections, and repetition of queries, from the terminal. In some embodiments, the server acquires utterance information by receiving a transcription of the user's speech from a speech recognition module executed on the terminal or on the server. The server uses a separate emotion classification model, for example a neural network trained on labeled emotion data, to map operation features and linguistic features to an emotion label or a continuous emotion score. The server then generates control information that specifies, for example, whether the system should use more polite wording, shorter answers, or additional explanatory context.

The server modifies the analysis prompt sentence and the response-generation prompt sentence based on the control information. For example, when the user emotional state indicates frustration, the server adds instructions such as “Use a polite and empathic tone” or “Add a short reassurance phrase at the beginning of the answer.” When the emotional state indicates urgency, the server may instruct the generative AI model to generate a more concise answer with the key location phrase at the beginning. By adjusting prompt sentences based on emotion, the server changes the token distribution and decoding behavior of the generative AI model so that the answers are technically optimized for readability and user comprehension, thereby reducing the need for repeated queries. This reduction in repeated queries directly lowers computational load and improves end-to-end latency.

The server configures data structures and internal modules so that the flow from user input to final answer remains deterministic and inspectable, even though the generative AI model performs parts of the language processing. The server uses a modular architecture in which a query-receiving module, a prompt-generation module, a model-invocation module, a database-access module, an emotion-analysis module, and a response-delivery module communicate via well-defined interfaces. Each module logs intermediate results and parameters, enabling offline analysis and tuning. For example, the server records each analysis prompt sentence, each extracted keyword, and each executed database query. This logging allows the server to refine prompt design and model parameters to further improve accuracy and response time.

Because the server shifts part of the linguistic ambiguity resolution from rigid rule-based parsing into a constrained generative AI model, and then feeds the model's structured outputs into an optimized database query pipeline, the system is not a mere automation of human mental steps. Instead, the system improves the technical functioning of the underlying computer system by reducing error rates in search key extraction, decreasing the number of failed or repeated queries, and improving cache locality in the database through more predictable query patterns. The server's use of structured data models for location information, hierarchical indexing, and feature-based similarity search further increases computational efficiency. The coordinated design of prompt sentences and decoding parameters ensures that the generative AI model behaves as a tightly controlled component in a larger, technically engineered pipeline.

In a further embodiment, the server locally deploys the generative AI model on a dedicated accelerator such as a graphics processing unit. The server partitions the model across multiple devices and uses batch processing to handle multiple user requests simultaneously. The server selects model size (for example, a smaller parameter count model for frequent keyword extraction tasks and a larger model for complex explanations) based on estimated request complexity, which is inferred from the length and structure of the natural-language inquiry sentence. This dynamic model selection reduces average processing time and power consumption while maintaining sufficient accuracy for the particular subtask. The server thereby improves the resource utilization of the computing hardware and provides a scalable solution for many concurrent users.

In another embodiment, the server applies data augmentation and continual learning techniques to improve the emotion analysis function and the mapping from natural-language expressions to item names. The server collects anonymized examples of user queries and the extracted item names, and periodically retrains a smaller auxiliary model that predicts item categories or emotion labels. The server uses a supervised learning algorithm such as stochastic gradient descent with a loss function like cross-entropy between predicted labels and true labels, and updates the model weights accordingly. By incrementally adapting to user-specific language and behavior, the server improves extraction accuracy, which in turn enhances database search performance and reduces the frequency of ambiguous results. Because the described system architecture integrates specific data structures (hierarchical location representation, indexed tables, feature vectors for historical storage), specific algorithmic steps (prompt-controlled keyword extraction, similarity-based candidate computation, emotion-conditioned prompt adjustment), and a concrete neural network configuration (transformer-based generative AI model with controlled decoding), the invention provides a technical solution that improves computer performance in terms of search accuracy, latency, and robustness of interaction. The server, terminal, and user each play a defined role: the user provides natural-language instructions and reviews the outputs; the terminal captures and displays data; the server orchestrates prompt generation, model invocation, database access, and emotion-based adaptation in a way that yields tangible technical benefits in the operation of the computing system.

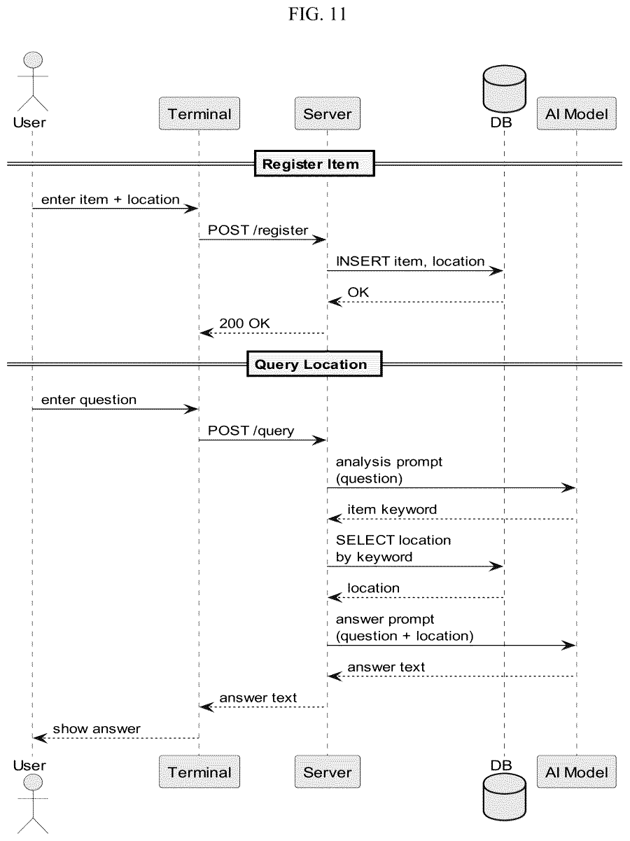

The following describes the processing flow using FIG. 11.

### Step 1:

User operates a terminal to launch an application or open a web page and selects a screen for registering item information.

Input: User provides an item name and a storage location description through an input device such as a touch panel or keyboard.

Output: Terminal holds the entered item name and storage location in memory as structured data (for example, key-value pairs such as “item_name” and “location”).

Terminal captures the raw text from the input fields, normalizes character encoding, performs basic validation such as checking for non-empty strings, and prepares the data for transmission to the server.

### Step 2:

Terminal constructs a registration request message containing the user identifier, the item name, and the storage location description.

Input: Terminal uses the structured item data created in Step 1 and a stored user identifier or session identifier.

Output: Terminal generates a serialized message, such as a JSON object, and sends it to the server over a network using a protocol such as HTTPS.

Terminal invokes a network communication library to open a secure connection, sets HTTP headers indicating content type, embeds the structured data into the message body, and initiates transmission to a predefined server endpoint.

### Step 3:

Server receives the registration request and parses the contained item information.

Input: Server obtains the serialized registration message from the terminal via the network interface.

Output: Server generates internal variables representing the user identifier, item name, and storage location description.

Server invokes a parsing routine of a JSON or similar decoder, validates expected fields, logs the reception event, and transforms the raw strings into a normalized internal representation (for example, trimming whitespace and standardizing letter case).

### Step 4:

Server stores the item identification information and storage location information into a database management program.

Input: Server uses the parsed item name and storage location description from Step 3.

Output: Server writes a new record to a database table that associates a user identifier, normalized item name, and normalized storage location as location information.

Server constructs a database insertion command, passes normalized values as parameters, and instructs the database management program to execute the command. The database engine writes the record to nonvolatile storage and updates relevant indexes so that later search operations on item name and user identifier can be executed efficiently.

### Step 5:

User later operates the terminal to input a natural-language inquiry sentence requesting the location of an item.

Input: User types or speaks a question such as “Where is my winter coat?” into a query input interface on the terminal.

Output: Terminal stores the natural-language question as a text string and associates it with the current user identifier or session identifier.

Terminal may display the entered question back to the user for confirmation and prepares the data as structured input for a query request message.

### Step 6:

Terminal constructs a query request message and sends it to the server.

Input: Terminal uses the natural-language inquiry sentence and the user identifier stored in Step 5.

Output: Terminal generates a serialized query message containing the inquiry sentence and user identifier and transmits it to the server via the network.

Terminal encodes the text and identifier into a JSON object or similar structure, sets appropriate HTTP headers, and sends the message to a designated query endpoint, then waits for a response while optionally displaying a “searching” indication.

### Step 7:

Server receives the query request and prepares an analysis prompt sentence for a generative AI model.

Input: Server obtains the serialized query message from the terminal and extracts the natural-language inquiry sentence and user identifier.

Output: Server generates an analysis prompt sentence that embeds the inquiry sentence within instructions telling the generative AI model how to extract keyword or intent information.

Server concatenates template text that defines the parsing task with the specific inquiry sentence. For example, the server creates a prompt sentence such as “You are a natural language parser for an item-location system. Input: a user question about where an item is stored. Task: extract only the item name mentioned by the user. Output: item name only. User question: ‘Where is my winter coat?’”. The server sets model parameters such as temperature and maximum token count to control output characteristics.

### Step 8:

Server invokes the generative AI model using the analysis prompt sentence to extract keyword or intent information.

Input: Server passes the analysis prompt sentence and model parameters to the generative AI model through an API or local inference engine.

Output: Server receives text output from the generative AI model that represents keyword information or intent information, such as an item name string.

Server sends the prompt to the model, which tokenizes the input, processes it through attention and feedforward layers, and generates tokens for the output. The server then decodes the tokens into text, trims extraneous whitespace, applies normalization (such as lowercasing), and verifies that the output conforms to expected patterns (for example, a single phrase without additional commentary).

### Step 9:

Server performs a database search using the extracted keyword or intent information.

Input: Server uses the normalized keyword information or intent information from Step 8 and the user identifier from Step 7.

Output: Server obtains a set of database records that contain storage location information associated with item identification information matching the extracted keyword.

Server constructs a database query, such as a parameterized SQL statement, that searches for records where the user identifier and item name satisfy a matching condition (e.g., case-insensitive equality or pattern matching). The database engine scans or uses indexes to locate matching records, computes any necessary similarity scores, and returns result rows to the server. The server then extracts the storage location fields from these rows and, optionally, ranks or filters them.

### Step 10:

Server generates a response-generation prompt sentence for the generative AI model based on the inquiry sentence and the retrieved location information.

Input: Server uses the original natural-language inquiry sentence from Step 7 and the storage location information obtained in Step 9.

Output: Server creates a response-generation prompt sentence that instructs the generative AI model to produce a natural-language answer consistent with the retrieved location information.

Server embeds the user question and a summary of the database results into a structured prompt, for example: “You are an assistant for an item-location system. The system has already searched its database and obtained the following result. User question: ‘Where is my winter coat?’ Database result: ‘The winter coat is stored on the left side of the bedroom closet.’ Task: Answer the user in one short English sentence that is consistent with the database result. Do not invent new locations.” The server sets model parameters to enforce short, deterministic output.

### Step 11:

Server invokes the generative AI model using the response-generation prompt sentence to generate a natural-language answer.

Input: Server submits the response-generation prompt sentence and model parameters to the generative AI model.

Output: Server obtains an answer sentence that states the item's storage location in natural language.

Server passes the prompt through the generative AI model, which internally computes attention over the prompt tokens and generates a response based on learned language patterns and the constraints specified in the prompt sentence. The server decodes the generated tokens, ensures that the text includes the main location information present in the database result, and discards any extraneous or conflicting statements. The server thus produces a finalized answer sentence for the user.

### Step 12:

Server transmits the generated answer sentence to the terminal.

Input: Server uses the validated answer sentence from Step 11 and the user identifier or connection context of the original request.

Output: Server produces a response message that contains the answer sentence and sends it to the terminal over the network.

Server serializes the answer sentence into a response payload, sets an appropriate status code and headers in the network protocol, and writes the response to the network socket associated with the terminal's pending request.

### Step 13:

Terminal receives the answer sentence and displays it to the user.

Input: Terminal obtains the response message containing the generated answer sentence from the server.

Output: Terminal renders the answer sentence on a display and, in some embodiments, outputs audio via a speaker.

Terminal parses the response payload, extracts the answer text, and updates user interface components to show the answer clearly, for example in a text area labeled “Result.” Terminal may scroll the view to ensure the answer is visible and, when audio output is enabled, passes the text to a text-to-speech module to read the answer aloud.

### Step 14:

Server derives candidate storage locations for similar items using past storage history data.

Input: Server uses past storage history records from the database and the keyword or intent information extracted in Step 8.

Output: Server calculates one or more candidate storage locations for items with attributes similar to the item referenced in the query and represents them as proposal information.

Server retrieves historical records for the same user that include item attributes and past storage locations, encodes these attributes into feature vectors, computes similarity scores between the queried item and historical items using an algorithm such as cosine similarity or distance-based metrics, and selects top-ranked storage locations. The server packages these candidate locations as structured records ready for suggestion generation.

### Step 15:

Server generates a proposal prompt sentence for the generative AI model to create natural-language storage suggestions.

Input: Server uses the candidate storage locations from Step 14 and, optionally, a description of the current item.

Output: Server creates a proposal prompt sentence that instructs the generative AI model to generate suggestion sentences based only on the provided candidate locations.

Server combines template text with the item description and candidate location list, for example: “You are an assistant that suggests storage locations for items. User item: ‘winter scarf’. Candidate storage locations from history: 1. ‘top drawer of the bedroom dresser’ 2. ‘right side of the bedroom closet shelf’. Task: Suggest to the user one or more suitable locations, rephrasing the candidate storage locations in natural English, without introducing locations not listed above.” The server thereby encodes explicit constraints into the prompt sentence.

### Step 16:

Server invokes the generative AI model with the proposal prompt sentence and generates suggestion text for candidate storage locations.

Input: Server submits the proposal prompt sentence and associated decoding constraints to the generative AI model.

Output: Server obtains a natural-language suggestion sentence describing candidate storage locations for the item.

Server allows the generative AI model to process the prompt and generate a concise recommendation that incorporates the candidate locations. The server decodes the output tokens, verifies that only listed candidate locations are mentioned, and formats the resulting text as proposal information. The server then sends this suggestion text to the terminal, which displays it to the user as an optional recommendation for future item storage.

### Step 17:

Server analyzes user emotional state and adjusts prompt sentences and presentation based on emotion.

Input: Server receives operation information and, where available, utterance information from the terminal, along with previously stored emotion analysis parameters.

Output: Server generates control information that modifies at least one of the analysis prompt sentence, the response-generation prompt sentence, and the answer sentence expression.

Server extracts features such as typing speed, correction frequency, repeated queries, and linguistic markers. The server feeds these features into an emotion analysis function, for example a trained classification model, and obtains an emotion label. Based on this label, the server alters subsequent prompt sentences by inserting instructions regarding tone, level of detail, or reassurance content. By doing so, the server adjusts how future generative AI model outputs are formed and how they are presented to the user, thereby reducing repeated interactions and improving communication efficiency.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional item-location management systems in facilities such as logistics centers, warehouses, libraries, and data centers often rely on rigid, form-based user interfaces and rule-based text parsers. These systems require users to input item identifiers and storage locations in predetermined formats, and they return search results in fixed templates. Such systems suffer from several technical problems when deployed in environments where operators interact with the system primarily through speech and where item locations are frequently updated.

First, when the system accepts voice input, the output of a speech recognition engine is often noisy, ambiguous, or inconsistent in formatting. Traditional systems typically perform simple keyword matching or handcrafted parsing on the recognized text. These approaches are brittle against variations in wording, recognition errors, and different user expressions. As a result, the system frequently fails to correctly identify the target item or the intended storage instruction, which leads to additional user interactions, repeated queries, and increased network and processor load. This degrades the overall efficiency and responsiveness of the computer system.

Second, conventional systems are not designed to integrate a generative AI model in a way that structurally improves the underlying computer processes. In many cases, a generative AI model, if used at all, is invoked in an ad hoc manner to produce a human-readable answer, without separating (i) extraction of machine-usable structured data and (ii) generation of user-facing natural language responses. This lack of separation means that the system either has to parse the generative output again to recover structured information or must maintain additional rule-based components, both of which increase processing complexity, memory usage, latency, and error propagation.

Third, existing systems typically maintain item location information in a database but do not provide an effective mechanism to automatically convert free-form user instructions into consistent, structured registration or update operations. This mismatch between unstructured user input and structured database schemas requires manual intervention or rigid input forms, preventing real-time, voice-driven registration of item locations and causing underutilization of the database and network resources that could otherwise support dynamic optimization of storage layouts.

Fourth, while some systems can propose storage locations based on static rules, they do not adequately exploit past storage history data and usage history data in combination with generative models to compute context-aware recommendations and to present them adaptively. In particular, conventional systems do not provide a technical framework for constructing and dynamically adjusting prompt sentences based on system context, such as historical data and user state, to control the behavior of a generative AI model. As a consequence, recommendations are often generic, not aligned with the actual usage patterns stored in the database, and not tailored to the operational context, thereby limiting the effectiveness of the computer-implemented optimization.

Fifth, emotion recognition, even if available, is usually treated as an external or cosmetic layer, for example only changing colors in the user interface. There is no systematic mechanism for using user emotion information as input to computational components that determine query interpretation, prompt construction, response style, and recommendation content. This omission prevents the system from adapting its processing pipeline to reduce user confusion, shorten interaction sequences, and avoid repeated or unnecessary calls to external services, all of which are computer-centric technical effects.

Therefore, there is a need for a computer-implemented system that (i) robustly transforms voice and text inputs into structured item identification and storage location information by using a generative AI model under explicit prompt control, (ii) tightly couples this structured information with database operations for search, registration, and update of item location information, (iii) computes recommended storage locations based on historical data and uses controlled prompt sentences to generate natural language explanations, and (iv) adjusts prompt contents, response generation, and presentation modes based on detected user emotion. Such a system should improve the reliability and efficiency of the overall computation, reduce unnecessary processing and network traffic, and enhance the system's ability to deliver accurate and context-aware item location information in real time.

The specific processing by the specific processing unit 290 of the data processing device 12 in Application Example 1 is realized by the following means.

The present invention provides a server comprising a processor and a memory storing instructions which, when executed by the processor, cause the processor to receive audio data including a user inquiry from an information processing terminal, to control a speech recognition process that converts the audio data into character string data, to receive inquiry data including the character string data from the information processing terminal, to generate a first prompt sentence that instructs a generative artificial intelligence model or a natural language processing model to analyze the character string data and to extract structured information identifying a target item, to input the first prompt sentence and the character string data into the generative artificial intelligence model or the natural language processing model and obtain, as the structured information, item identification information for the target item, to execute a search process based on the item identification information on a data management apparatus that stores item location information and obtain location information of the target item from the data management apparatus, to generate a second prompt sentence that instructs the generative artificial intelligence model to generate a natural language response text based on the obtained location information and the user inquiry, to input the second prompt sentence and the location information into the generative artificial intelligence model and obtain the response text in natural language, and to transmit the response text to the information processing terminal so that the information processing terminal presents the response text to the user by at least one of visual display and audio output. This enables the server to offload complex, variable natural language analysis and response generation to the generative artificial intelligence model while maintaining a clear separation between structured data extraction and user-facing text generation, thereby improving the robustness and efficiency of item identification and response generation even when the speech recognition output is noisy or variable.

The present invention further provides the server configured to receive, from the information processing terminal, input data including a registration instruction expressed by at least one of voice and text, the registration instruction specifying an item and a storage location; to generate a third prompt sentence that instructs the generative artificial intelligence model to extract, from the input data, structured information including item identification information and storage location information; to input the third prompt sentence and the input data into the generative artificial intelligence model and obtain the structured information including the item identification information and the storage location information; and to cause the data management apparatus to perform at least one of registration and update of item location information of the item based on the structured information. This enables automatic and consistent transformation of unstructured user registration instructions into database-ready structured data, thereby reducing manual input constraints, improving the accuracy of location registration, and optimizing the utilization of the database and network resources. The present invention further provides the server configured to refer to past storage history information and usage history information related to items that are the same as or similar to the item; to calculate a recommended storage location for the item based on the past storage history information and the usage history information; to generate a fourth prompt sentence that instructs the generative artificial intelligence model to generate, based on the recommended storage location and at least part of the past storage history information, a natural language message including a recommendation and a reason for the recommendation; to input the fourth prompt sentence and data including the recommended storage location into the generative artificial intelligence model and obtain the natural language message; and to transmit the natural language message to the information processing terminal so that the information processing terminal presents the recommended storage location and the explanation to the user. This enables the server to combine deterministic computation of recommended locations using historical data with controlled, context-rich natural language explanations generated by the generative artificial intelligence model, thereby providing technically grounded and operationally meaningful recommendations while maintaining low processing overhead for the core optimization logic.

The present invention further provides the server configured to receive emotion information indicating an emotional state of the user from an emotion recognition processing apparatus; and to adjust, based on the emotion information, at least one of contents of the first to fourth prompt sentences, the response text, and a presentation mode of the recommended storage location. This enables the server to dynamically modify the behavior of the generative artificial intelligence model and the manner in which results are presented, such that, for example, instructions can be made more explicit and step-by-step when the user is estimated to be confused, or more concise when the user is estimated to be confident, thereby reducing repeated queries, unnecessary processing, and network traffic, and improving the overall responsiveness and stability of the computer-implemented system.

The term “information processing terminal” refers to an electronic apparatus including at least a processor, a memory, an input device, a display device, and a communication interface, configured to exchange data with a server over a communication network and to present information to a user by at least one of visual display and audio output.

The term “audio data” refers to digital data representing sound captured by an input device such as a microphone, including sampled and encoded waveforms suitable for processing by a speech recognition process.

The term “user inquiry” refers to information expressing a question, request, or command from a user regarding at least one item or item location, the information being expressed in natural language by at least one of voice and text.

The term “speech recognition process” refers to a computational process that converts audio data representing spoken language into character string data representing text corresponding to the spoken content.

The term “character string data” refers to data including one or more sequences of characters, symbols, or tokens representing natural language text obtained from a speech recognition process or from user text input.

The term “inquiry data” refers to data including at least character string data representing a user inquiry and optionally metadata such as a user identifier, a terminal identifier, or a timestamp.

The term “generative artificial intelligence model” refers to a machine-learned computational model configured to generate output data, including at least natural language text, in response to input data such as prompt sentences and structured information.

The term “natural language processing model” refers to a computational model configured to analyze and process natural language text to perform tasks such as tokenization, parsing, semantic interpretation, or information extraction.

The term “prompt sentence” refers to text data provided as input to a generative artificial intelligence model or a natural language processing model, the text data specifying at least a processing objective, constraints, or desired format of output to control the behavior of the model.

The term “structured information” refers to data organized according to a predefined schema or format, including one or more fields such as item identification information and storage location information, that can be processed by a database or a program without further natural language interpretation.

The term “item identification information” refers to structured information that uniquely or specifically identifies an item, such as an item name, an item code, a category, or an identifier assigned in a management system.

The term “target item” refers to an item that is the subject of a user inquiry or a registration instruction and for which item location information is to be searched, registered, or updated in a data management apparatus.

The term “data management apparatus” refers to a computing resource, including at least a storage device and a control unit, configured to store, manage, and provide access to item location information, storage history information, and usage history information.

The term “item location information” refers to structured information indicating where an item is stored, including at least information indicating a physical storage place, a digital storage place, or both.

The term “physical storage place” refers to a location in a physical environment, such as a shelf, rack, bin, room, zone, or area within a facility, where an item is stored.

The term “digital storage place” refers to a logical or virtual location within an information system where digital data related to an item is stored, such as a file path, a database record, a memory region, or a storage object identifier.

The term “response text” refers to natural language text generated or selected by a server, directly or via a generative artificial intelligence model, to answer a user inquiry about an item or an item location.

The term “registration instruction” refers to a user instruction, expressed in natural language by at least one of voice and text, that specifies registration or update of item location information, including at least an item and a storage location.

The term “storage location information” refers to structured information specifying a location to store an item, including at least one of a physical storage place and a digital storage place.

The term “past storage history information” refers to stored data representing records of previous storage locations or movements of items over time within a management system.

The term “usage history information” refers to stored data representing past usage of items, including at least retrieval frequency, movement events, access logs, or transaction records associated with items.

The term “recommended storage location” refers to a storage place computed by the server based on at least past storage history information and usage history information, and proposed as a preferred location for storing an item.

The term “natural language message” refers to a sequence of words or sentences in a human language, generated or formatted for presentation to a user, including at least an explanation of a recommendation, a reason, or an instruction.

The term “emotion information” refers to data indicating an estimated emotional state of a user, such as stress, confusion, satisfaction, frustration, or confidence, obtained from an emotion recognition processing apparatus.

The term “emotion recognition processing apparatus” refers to a device or computational component configured to analyze user-related signals, including at least one of voice features, facial expressions, physiological signals, and interaction patterns, and to output emotion information indicating an estimated emotional state.

The term “presentation mode” refers to a manner in which information is provided to a user, including at least one of visual display format, audio output style, level of detail, and interaction sequence.

The term “context information” refers to information related to circumstances of a user inquiry or registration instruction, including at least past storage location information, usage history information, terminal state, and emotion information.

The term “information processing terminal that accepts voice input” refers to an information processing terminal configured to capture user voice via an audio input device and to transmit corresponding audio data or character string data to a server.

In one embodiment, a server cooperates with one or more terminals operated by users in a facility such as a logistics center, warehouse, library, or data center. The server manages item location information stored in a data management apparatus and uses a generative AI model controlled by prompt sentences to convert unstructured user input into structured data and natural language responses.

The server includes at least one processor, a main memory, a non-volatile storage device, and a communication interface. The server executes an operating system such as a general-purpose server OS and application software implementing the functions described herein. The server connects, via a wired or wireless communication network, to the terminals and to external computation services. The data management apparatus is implemented, for example, by a relational database management system executing on the same physical machine as the server or on another machine connected over a network. The terminals include smartphones, tablet devices, handheld scanners with displays, or wearable devices, each having a processor, memory, display, microphone, speaker, and a wireless communication interface. The terminal executes a client application that provides a voice- and text-based user interface. The terminal uses its microphone and an audio codec to capture the user's speech, digitize the audio into, for example, linear PCM samples at a predetermined sampling rate, and store the samples in a buffer in memory. The terminal then uses an API of a speech recognition service to send the captured audio to a speech recognition process. The speech recognition service may run locally on the terminal or on a remote computation server. In one example, the terminal uses an HTTP-based API of a cloud speech recognition service, with parameters specifying language, encoding format, and sampling rate. The speech recognition process converts the audio data into character string data representing the recognized text.

The server receives the character string data, either directly from the terminal when speech recognition is performed on the terminal, or indirectly when the terminal forwards the text produced by an external recognition service. The server stores the received character string data, together with metadata such as a user identifier, a terminal identifier, and a timestamp, in memory and optionally in a log table of the database. The server then generates a prompt sentence that instructs a generative AI model or a natural language processing model to extract structured information from the character string data.

The server, in one embodiment, uses as the generative AI model a transformer-based neural network trained on sequences of tokens. The generative AI model internally comprises an embedding layer, a plurality of self-attention layers, feed-forward layers, and a final projection layer. The embedding layer converts input tokens into continuous vectors. Each self-attention layer computes attention weights over the token sequence based on learned query, key, and value matrices. The feed-forward layers apply non-linear transformations to the attention outputs. The model has been trained offline using a corpus of text including question-answer pairs and structured annotation examples, by minimizing a loss function such as cross-entropy between predicted token sequences and target sequences, and updating weight parameters by gradient-based optimization. During inference in the present system, the model receives an input text sequence including a prompt sentence and user text and produces an output text sequence.

The server constructs a first prompt sentence that explicitly specifies the task of structured information extraction. For example, the server uses a prompt sentence such as: “The user asked: ‘Where is product X stored?’

Extract the product name or product code from this question and answer in the format: itemName=<itemName>, itemCode=<itemCode>.”

The server concatenates this prompt sentence and the character string data, tokenizes the combined text using a tokenizer compatible with the generative AI model, and transmits the token sequence to the model through an API. The server receives from the model an output text containing structured information, such as “itemName=product X, itemCode=(none).”

The server then parses this output text deterministically, using simple string matching and pattern recognition, to obtain structured information fields stored in memory as records with keys such as “itemName” and “itemCode.” Because the server constrains the model's behavior via prompt design and expects a specific output format, the server can avoid heavy post-processing and can achieve fast and reliable extraction of structured item identification information.

The server, using the structured information, issues a search query to the data management apparatus. The server uses a database driver to connect to the relational database, constructs a parameterized SQL statement based on the item identification information, and executes the statement. The database stores item location information in tables having fields such as item identifier, physical storage place identifier, digital storage place identifier, and timestamps.

The server obtains query results from the database, transforms each row into an internal data structure, and caches frequently accessed results in memory to reduce repeated disk access and network latency.

The server then generates a second prompt sentence to instruct the generative AI model to produce a user-facing response text. The server, in one example, uses a prompt sentence such as:
“generative AI model, please create a concise answer.

The user asked: ‘Where is product X stored?’

The database result is: product X is in Shelf Y, Section Z, Bin 3.

Return one short English sentence directly telling the user where product X is.”

The server concatenates this second prompt sentence with a representation of the database result, tokenizes the combined text, and sends it to the generative AI model. The server receives an output sequence such as “Product X is stored on shelf Y in section Z, bin 3.” The server validates that all identifiers (e.g., shelf and section) appearing in the output are consistent with the database result, and rejects or corrects any extra or conflicting information. The server then transmits the validated response text to the terminal via a network interface using a structured communication protocol.

The terminal receives the response text, displays the text on its screen in a user interface component, and optionally converts the text to speech using a text-to-speech engine. The terminal uses local software frameworks, such as operating system UI libraries, to render the text and control fonts, colors, and layout. The terminal uses the speaker or a connected headset to play synthesized audio so that the user can obtain the answer without looking at the display.

In a registration scenario, the user uses voice or text to instruct the system to register or update an item's storage location. The terminal captures and transmits the instruction in the same manner described above, converting speech into character string data. The server receives an input such as “Register product X at Shelf Y, Section Z.” The server then generates a third prompt sentence, for example:
“generative AI model, read this instruction: ‘Register product X at Shelf Y, Section Z.’

Extract itemName, shelfId, and sectionId and return them in the format: itemName=<itemName>, shelfId=<shelfId>, sectionId=<sectionId>.”

The server sends the third prompt sentence and the instruction text to the generative AI model, receives an output text such as “itemName=product X, shelfId=Y, sectionId=Z,” and parses the output into structured fields. The server verifies that the shelf and section identifiers exist in the database's master tables. If the identifiers are valid, the server issues an INSERT or UPDATE command to the database to register or update the item location information. This process allows the system to convert a wide variety of natural language registration instructions into stable database operations while maintaining consistency and referential integrity.

The server, in a recommendation scenario, periodically or on-demand reads past storage history information and usage history information from the database. The server aggregates, for each item or item type, metrics such as retrieval frequency, average time to retrieve, and movement count. The server applies deterministic algorithms, such as sorting by frequency and calculating weighted distances to packing stations, to compute candidate recommended storage locations. The server selects one or more recommended locations that minimize an objective function, for example a linear combination of walking distance and handling frequency.

The server then generates a fourth prompt sentence to convert the recommended locations and their basis into a user-readable explanation. For example, the server uses a prompt sentence such as:
“generative AI model, the item type X is frequently picked.

We recommend storing it near packing station A, Shelves S1-S3.

Generate a short explanation for a warehouse worker in English.”

The server sends this prompt sentence and the computed recommendation data to the generative AI model and receives a natural language message such as “Because product X is picked very often, we recommend placing it near packing station A on shelves S1 to S3 to reduce walking time.” The server transmits this message to the terminal. The terminal displays the recommended locations and explanation, enabling the user to understand the technical basis of the recommendation.

The server further receives emotion information from an emotion recognition processing apparatus. The emotion recognition processing apparatus may analyze features extracted from voice signals, such as pitch, intensity, and speech rate, and from interaction logs such as repeated queries or correction attempts. The emotion recognition processing apparatus computes feature vectors and applies a trained classifier model, which may be a neural network trained with labeled emotional states using a loss function such as cross-entropy. The classifier outputs emotion information indicating categories such as confusion, frustration, or confidence, possibly with probability scores.

The server uses the emotion information to modify the contents of prompt sentences and the style of responses. For example, when the emotion information indicates a high probability of confusion, the server generates prompt sentences requesting more detailed and step-by-step explanations from the generative AI model. When the emotion information indicates confidence, the server generates prompt sentences instructing the model to answer more concisely. The server thus changes the number of tokens and the structure of prompt sentences based on emotion information, which leads to shorter or longer model outputs and different levels of detail. As a result, the server can reduce unnecessary follow-up queries and repeated model calls, which directly reduces processing time and network traffic.

The server, by structuring the interaction with the generative AI model through multiple specialized prompt sentences (for extraction, answering, registration, and recommendation explanation), achieves a technical improvement over systems that merely pass user questions to a model and output the model's responses. In the present system, the server separates the functions of structured data extraction and natural language generation. The server uses deterministic parsing of model outputs, coupled with database access, to create a stable data flow from unstructured input to structured storage and back to natural language output. This separation reduces error propagation because the server can validate structured fields against database schemas and discard outputs that do not satisfy syntactic constraints.

The server also reduces computational cost by using distinct prompt sentences tailored to each task. For extraction, the prompt sentences constrain the model to produce short outputs with fixed patterns, which reduces the number of generated tokens and therefore decreases inference time. For explanation, the server includes only the minimum necessary data in the prompt sentences, avoiding long context windows. This control of token counts and context length directly reduces the computational load on the generative AI model.

The server improves data management by enforcing a specific internal data structure for item location information, storage history information, and usage history information. The server stores these data in normalized tables with indexed fields for item identifiers and location identifiers, which allows efficient search and aggregation. Because the server always uses structured information produced via prompt-controlled extraction, the server avoids inconsistent or malformed identifiers that would otherwise degrade index performance.

The terminals contribute to the technical effect by implementing a specific interaction pattern with the server. The terminals encode and send audio data only when a voice input session is activated, thereby reducing unnecessary network traffic. The terminals cache certain server responses and render them locally, without re-querying the server for identical or near-identical requests, based on local identifiers and timestamps. This cooperation between terminals and server contributes to reducing communication load and improving responsiveness.

The overall configuration, including the server, terminals, generative AI model, speech recognition process, and emotion recognition processing apparatus, is not a mere automation of human decision making. The server applies specific algorithms and data structures to constrain and verify model outputs, to perform efficient database queries, to compute data-driven recommendations, and to adapt prompt sentences based on emotion information. These operations result in improved processing speed, reduced errors in item identification and location registration, and decreased network and computation overhead compared to systems that do not separate structured extraction and generative answering or that do not use emotion-based prompt control. As a consequence, the invention improves the functioning of the computer system itself, including improved data management, faster and more accurate searches, and a more efficient use of computational resources.

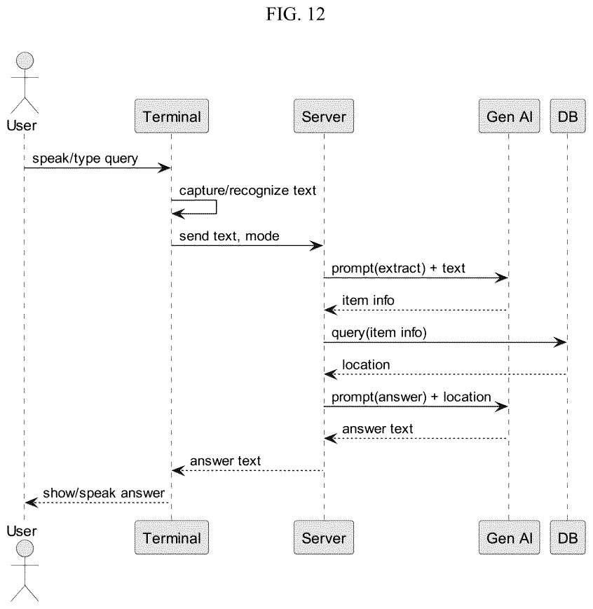

The following describes the processing flow using FIG. 12.

### Step 1:

The user activates a warehouse application on the terminal and initiates a query or registration operation.

The user provides, as input, a natural language utterance such as “Where is product X stored?” or “Register product X at shelf Y, section Z.”

The terminal receives this input via a touch event on a microphone button or a text input field.

The terminal determines whether the input mode is voice or text, and sets an internal mode flag accordingly.

The output of this step is a control state in the terminal indicating the selected operation type (query or registration) and input mode (voice or text).

### Step 2:

The terminal, when the input mode is voice, captures the user's utterance using a microphone and an audio codec.

The terminal receives, as input, an analog audio signal from the microphone and digitizes the signal into audio data, for example, 16-bit PCM samples at a predetermined sampling rate.

The terminal processes the audio data by framing it into fixed-length buffers and optionally applying compression or encoding (such as linear PCM, FLAC, or another supported format) suitable for a speech recognition service.

The output of this step is a sequence of encoded audio data buffers stored in the terminal's memory.

### Step 3:

The terminal sends the encoded audio data to a speech recognition process.

The terminal receives, as input, the audio data buffers from its memory and network configuration parameters such as server address and authentication tokens.

The terminal constructs a request packet, encapsulating the audio data and metadata (language code, sampling rate, encoding type) into an HTTP or other protocol message, and transmits the packet through a network interface.

The output of this step is a network request sent toward a speech recognition server or a local speech recognition module.

### Step 4:

The terminal receives a transcription result from the speech recognition process.

The terminal receives, as input, a server response containing character string data representing recognized text, typically in a structured format such as JSON.

The terminal parses the response, extracts the recognized text field, and stores it in a variable associated with the current user session.

The terminal may display the recognized text to the user for confirmation.

The output of this step is character string data corresponding to the user's original utterance.

### Step 5:

The terminal, when the input mode is text, directly collects the user's typed text as character string data.

The terminal receives, as input, key events from a virtual keyboard and aggregates them into a text string.

The terminal cleans the text (for example, trimming whitespace) and associates it with the current operation type (query or registration).

The output of this step is character string data representing the user's inquiry or registration instruction.

### Step 6:

The terminal sends the character string data and operation type to the server.

The terminal receives, as input, the character string data and operation metadata (operation type, user identifier, terminal identifier) from its application state.

The terminal packages these data into a request message (for example, a JSON body in an HTTP POST request) and transmits the message via a communication interface to the server. The output of this step is a network request containing text input and context information delivered to the server.

### Step 7:

The server receives the request and stores the input data in working memory.

The server receives, as input, the network request including the character string data, operation type, and metadata.

The server parses the request, extracts the relevant fields, validates user authentication and authorization, and logs the input into a log structure or database table for traceability.

The output of this step is a set of internal variables holding the user text, operation type, and associated identifiers.

### Step 8:

The server generates a first prompt sentence to instruct a generative AI model or natural language processing model to extract structured information from the character string data.

The server receives, as input, the raw character string data and the operation type.

The server selects a prompt template based on the operation type (query versus registration) and fills in variable portions with the user text. For example, for a query, the server may generate:

“The user asked: ‘Where is product X stored?’

Extract the product name or product code from this question and answer in the format: itemName=<itemName>, itemCode=<itemCode>”

The server combines the template and the actual text to form a complete prompt sentence.

The output of this step is a first prompt sentence tailored to the extraction task.

### Step 9:

The server calls the generative AI model with the first prompt sentence and the character string data to obtain structured information.

The server receives, as input, the first prompt sentence and the user's text.

The server concatenates them into a single text sequence, tokenizes the sequence according to the model's tokenizer, and sends the token sequence to the model via a model API.

The generative AI model processes the token sequence with its internal neural network (for example, a transformer with multiple attention layers) to produce an output token sequence.

The server decodes the output token sequence back into text, obtaining a response such as “itemName=product X, itemCode=(none).”

The output of this step is a textual representation of structured information.

### Step 10:

The server parses the model's textual output to obtain structured fields.

The server receives, as input, the output text from the generative AI model.

The server applies deterministic parsing rules (such as splitting by delimiters, matching specific labels “itemName=” and “itemCode=”) to extract values and validate their formats.

The server converts the extracted values into typed fields such as strings or integers and stores them in an internal data structure representing structured information.

The output of this step is structured information including item identification information and, in the registration case, storage location information.

### Step 11:

The server searches the data management apparatus for item location information based on the structured item identification information.

The server receives, as input, the structured item identification information (e.g., item name, item code) and database connection parameters.

The server constructs a parameterized query (for example, SQL) using the item identification fields and executes the query through a database driver.

The database engine performs index lookups and table scans according to the query, and returns one or more rows containing item location information.

The output of this step is a result set containing item location information for the target item, or an indication that no matching record exists.

### Step 12:

The server normalizes and formats the retrieved item location information into an internal representation.

The server receives, as input, the result set from the database.

The server iterates over the result rows, maps columns such as shelf identifier, section identifier, bin identifier, and digital location reference into a standard internal structure, and may select the most relevant record according to predefined rules (for example, most recent update).

The server may also combine physical and digital location information into a unified representation.

The output of this step is a normalized item location data structure ready for response generation.

### Step 13:

The server handles the registration or update of item location information when the operation type is registration.

The server receives, as input, structured information produced from a registration instruction, including item identification information and storage location information.

The server validates the storage location fields by querying master tables for shelves, sections, or digital repositories, and checks referential integrity constraints.

If validation is successful, the server constructs an INSERT or UPDATE command and sends it to the database. The database writes or modifies the corresponding records and returns a success status.

The output of this step is an updated state of the database and a confirmation status for the registration operation.

### Step 14:

The server computes recommended storage locations based on past storage history information and usage history information.

The server receives, as input, item identification information and access to tables containing history and usage data.

The server aggregates history records (for example, counts of retrievals, average retrieval time, number of relocations) for items of the same or similar type by executing analytic queries.

The server applies an algorithm that scores candidate storage locations, for example, by computing a weighted sum of distance to critical points and item frequency, and then selects locations that maximize the score.

The output of this step is a recommended storage location or a ranked list of candidate locations.

### Step 15:

The server generates a second prompt sentence to obtain a natural language response text for a location query.

The server receives, as input, the normalized item location data and the original user inquiry.

The server selects a response template and constructs a prompt sentence, such as:
“generative AI model, please create a concise answer.

The user asked: ‘Where is product X stored?’

The database result is: product X is in Shelf Y, Section Z, Bin 3.

Return one short English sentence directly telling the user where product X is.”

The server embeds the actual item identifiers into the template.

The output of this step is a second prompt sentence customized for the current query and location.

### Step 16:

The server calls the generative AI model with the second prompt sentence and the location information to generate a response text.

The server receives, as input, the second prompt sentence and a textual representation of the location information.

The server concatenates them, tokenizes the combined text, and sends it to the model. The model processes the tokens and outputs a token sequence representing a natural language answer.

The server decodes the output tokens into a string such as “Product X is stored on shelf Y in section Z, bin 3.”

The output of this step is a natural language response text suitable for presentation to the user.

### Step 17:

The server generates a third prompt sentence to obtain structured fields for registration instructions.

The server receives, as input, the raw registration instruction text.

The server constructs a prompt sentence such as:
“generative AI model, read this instruction: ‘Register product X at Shelf Y, Section Z.’

Extract itemName, shelfId, and sectionId and return them in the format: itemName=<itemName>, shelfId=<shelfId>, sectionId=<sectionId>.”

The server concatenates the prompt sentence with the instruction text to control the model's extraction behavior.

The output of this step is a third prompt sentence associated with the registration extraction task.

### Step 18:

The server generates a fourth prompt sentence to produce an explanation of a recommended storage location.

The server receives, as input, the recommended storage location data and summary statistics from the computed history and usage information.

The server constructs a prompt sentence such as:
“generative AI model, the item type X is frequently picked.

We recommend storing it near packing station A, Shelves S1-S3.

Generate a short explanation for a warehouse worker in English.”

The server inserts real item type identifiers and location codes into this template.

The output of this step is a fourth prompt sentence destined for producing an explanatory message.

### Step 19:

The server forwards the third or fourth prompt sentences and their associated data to the generative AI model and receives natural language or structured outputs.

The server receives, as input, the selected prompt sentence (third or fourth) and corresponding data (registration instruction text or recommendation data).

The server tokenizes and sends the combined text to the generative AI model, which returns an output sequence. For the third prompt, the output is a text with structured field assignments; for the fourth prompt, the output is a natural language explanation.

The server decodes the outputs into strings and, for structured outputs, parses them to extract field values.

The output of this step is either structured registration data or an explanatory natural language message.

### Step 20:

The server receives emotion information from an emotion recognition processing apparatus and adjusts prompt contents and response characteristics.

The server receives, as input, emotion information indicating an emotional state such as confusion, frustration, or confidence, possibly with confidence scores.

The server selects prompt variants based on the emotion information, for example, adding instructions like “explain step-by-step” when confusion is high or “answer very briefly” when confidence is high. The server may also modify output length constraints or detail level parameters.

The server updates internal settings that influence how the first to fourth prompt sentences are constructed, and how detailed responses and explanations should be.

The output of this step is a set of adjusted prompt sentences and response-style parameters aligned with the current emotion state.

### Step 21:

The server creates response packets for the terminal containing response texts, structured data, and optional recommendation explanations.

The server receives, as input, the natural language response text for a query, confirmation messages for registrations, and any recommendation messages.

The server encapsulates these outputs into response objects with fields such as message type, content, item identifiers, and location descriptors, and serializes the objects into a network-friendly format.

The server sends the serialized responses via its communication interface to the terminal identified in the original request.

The output of this step is a network response message containing all necessary information for user presentation.

### Step 22:

The terminal receives the response from the server and prepares the information for display and/or audio output.

The terminal receives, as input, the network response containing response text, item location data, and optional explanation messages.

The terminal deserializes the message, extracts fields, and updates its internal state to reflect the new information. The terminal chooses appropriate UI components (text labels, lists, maps) and decides whether to trigger text-to-speech based on user settings.

The output of this step is a prepared set of display and audio instructions for the terminal's user interface.

### Step 23:

The terminal displays the response text and, where applicable, visual indicators of item locations and recommendations.

The terminal receives, as input, prepared UI data including response text strings, item location identifiers, and optional recommendation explanations.

The terminal renders text on the display, draws icons or highlights corresponding to shelves, sections, or digital folders, and arranges the information in an easily readable layout.

The terminal may also call a text-to-speech module with the response text to generate an audio stream and play it through the speaker.

The output of this step is a visual and/or auditory presentation of item location information, registration confirmations, and storage recommendations to the user.

### Step 24:

The user reads or listens to the information presented by the terminal and interacts further if necessary.

The user receives, as input, the displayed text, icons, and spoken messages from the terminal. The user interprets the item location information to physically locate items, confirms that registrations or updates have been correctly performed, or evaluates storage recommendations. If needed, the user initiates additional queries or corrections, which cause the process to repeat from earlier steps.

The output of this step is user feedback and subsequent inputs that drive further cycles of the system's processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information management systems that store and retrieve location information for objects typically rely on simple keyword matching and fixed rule-based logic. Such systems often require users to manually define categories and storage locations, and to remember those rules when registering and searching for objects. As a result, these systems are limited in their ability to flexibly adapt to diverse user environments, changing storage habits, and ambiguous or natural-language user inquiries.

Furthermore, known systems generally treat item registration, category determination, storage recommendation, and retrieval as separate functions. They do not exploit modern generative artificial intelligence models in an integrated manner to (i) classify objects based on free-form descriptions, (ii) generate context-aware storage recommendations using past storage histories, and (iii) produce natural-language responses tailored to the user's emotional state. This separation leads to fragmented processing pipelines, increased complexity for developers and operators, and inconsistent user experiences.

In addition, most existing systems do not effectively leverage accumulated storage history data as a feedback signal to improve subsequent recommendations in a closed loop. Past storage decisions are often stored merely as logs, without being systematically reused to refine prompt sentences for generative artificial intelligence models or to adjust ranking of candidate storage locations. This leads to suboptimal utilization of historical data and reduces the system's capability to improve over time.

Moreover, conventional natural-language interfaces generally treat user input only as a query, without incorporating factors such as user emotion and user attributes into the underlying computational process. As a consequence, these interfaces cannot robustly handle vague, emotionally charged, or context-dependent queries, and they may generate responses that are technically correct but poorly aligned with user expectations or comfort. This results in lower usability and higher cognitive burden on the user.

There is therefore a need for an improved computer-implemented system and corresponding processing method that: (i) unifies item registration, classification, storage recommendation, and retrieval under a single processing framework; (ii) utilizes a generative information processing model via structured prompt sentences to perform both classification and natural-language response generation; (iii) builds and maintains a storage history that is explicitly reused to refine future recommendations and prompts; and (iv) incorporates an emotion analysis function to adjust response content and presentation in a manner that improves the effectiveness of the underlying computing processes and the overall human-computer interaction.

The specific processing by the specific processing unit 290 of the data processing device 12 in Example 2 is realized by the following means.

The present invention provides a server comprising a processor and a storage device, the processor being configured to execute instructions to: receive object information obtained from a user via an information processing terminal, and record, in the storage device, location information corresponding to the object information; analyze, using a natural language processing technique, an inquiry sentence obtained from the user via the information processing terminal, and retrieve from the storage device and provide location information corresponding to the object information; generate, based on attribute information and description information related to the object information, a structured prompt sentence to be input to a generative information processing model, and determine classification information of the object information by using computation processing of the generative information processing model; acquire, from the storage device, storage history information of object information belonging to a same or similar classification information based on the determined classification information, and extract and rank candidate storage locations of the object information based on the storage history information; generate, based on the candidate storage locations and the classification information, a proposal prompt sentence to be input to the generative information processing model, and generate a storage place proposal sentence in a natural language by using computation processing of the generative information processing model; estimate an emotion state of the user by using an emotion analysis function, analyze the emotion state of the user, and adjust, based on the emotion state, a presentation method of the location information and content or expression of the storage place proposal sentence; and record, in the storage device as storage history information, a storage location selected or input by the user based on the storage place proposal sentence in association with the object information, and reuse the storage history information for extraction of a subsequent candidate storage location and generation of a subsequent prompt sentence. This enables improvement of computer functionality by providing an integrated processing architecture in which a generative information processing model is driven by dynamically constructed prompt sentences including classification information, storage history information, and user emotion information, so that the server can more accurately determine object categories, more effectively compute and rank candidate storage locations based on accumulated historical data, and more efficiently generate context-appropriate natural-language responses, thereby reducing computational redundancy, enhancing the adaptability of the storage recommendation and retrieval processes, and improving the overall performance and usability of the computer-implemented information management system.

The term “system” refers to a combination of one or more hardware devices and one or more software components that cooperate to execute information processing functions described in the present disclosure.

The term “processor” refers to one or more hardware processing units, such as a central processing unit, a graphics processing unit, or any other arithmetic and logic execution unit, configured to execute instructions stored in a memory to perform the operations described herein.

The term “storage device” refers to one or more hardware memory components, such as semiconductor memory, magnetic storage, or optical storage, configured to store data, programs, and models used by the processor.

The term “information processing terminal” refers to any computing apparatus operated by a user, such as a mobile communication device, a portable information device, or a desktop information device, that is capable of transmitting and receiving data to and from the system.

The term “user” refers to a human operator who interacts with the system through an information processing terminal to register objects, request information, and receive proposals or responses.

The term “object information” refers to information representing an item to be managed by the system, including at least a designation of the item and optionally attribute information such as size, usage, or descriptive text.

The term “location information” refers to information that identifies a physical place or a digital storage context associated with an object, such as a room, a container, a shelf, a directory, or a virtual storage area.

The term “attribute information” refers to data describing properties or characteristics of an object, including but not limited to type, category hint, size, usage frequency, or environment of use.

The term “description information” refers to free-form or semi-structured textual information entered by the user that explains or characterizes the object, and that can be processed by language processing functions of the system.

The term “natural language processing technique” refers to a computation method that analyzes, interprets, or transforms human language text, including methods such as tokenization, syntactic analysis, semantic analysis, or intent recognition.

The term “inquiry sentence” refers to a natural-language expression provided by the user to the system, requesting information about an object, its location, or related storage recommendations.

The term “generative information processing model” refers to a machine learning model, such as a neural network model, that is configured to generate output data including text or classification results in response to input data, including a prompt sentence.

The term “prompt sentence” refers to a structured or semi-structured text input that is provided to a generative information processing model in order to condition or control the model's output behavior.

The term “classification information” refers to information indicating a category or group to which an object belongs, determined by the system based on object information and processing by the generative information processing model.

The term “storage history information” refers to recorded data indicating one or more past storage locations and associated context for one or more objects, including at least an identifier of the object, a classification, a location, and a time of storage.

The term “candidate storage location” refers to a location that is identified by the system as a possible storage place for an object, based on classification information and storage history information.

The term “proposal prompt sentence” refers to a prompt sentence that is constructed to cause the generative information processing model to generate a natural-language proposal for a storage location or related guidance.

The term “storage place proposal sentence” refers to a natural-language text generated by the generative information processing model that recommends one or more storage locations or provides guidance regarding storage of an object.

The term “emotion analysis function” refers to a computation function that estimates or infers an emotion state of a user from input data, such as text, voice, or interaction patterns, using rule-based methods or machine learning methods.

The term “emotion state” refers to information representing an estimated emotional condition of the user, such as comfort, frustration, satisfaction, or other affective states, derived by the emotion analysis function.

The term “presentation method” refers to a manner in which information, including location information and storage place proposal sentences, is displayed or communicated to the user, including wording, tone, level of detail, or visual formatting.

The term “user attribute information” refers to data associated with a user, such as user preferences, usage patterns, profile information, or environment characteristics, that can be used by the system to customize processing or responses.

The term “dialogue generation process” refers to a computation process that generates natural-language text for interaction with a user, such as responses, explanations, or proposals, based on one or more inputs including prompt sentences.

The term “classification estimation process” refers to a computation process that predicts or infers a class, label, or category for given input data, such as object information, using a statistical or machine learning model.

The term “information processing mechanism” refers to a hardware and software configuration, including one or more models and supporting logic, that collectively performs generative, classification, or other information processing tasks described herein.

In one embodiment, a server cooperates with one or more terminals operated by a user to implement the system described in the claims. The server includes at least one processor, a main memory, a non-volatile storage device, and a communication interface connected to a communication network. The terminal includes a processor, a display, an input interface, a local memory, and a communication interface capable of exchanging data with the server via a wired or wireless network.

The server executes an operating system such as a general-purpose server operating system, and runs an application program implemented, for example, using a web framework or an application framework. The server further executes a database management system such as a relational database engine, and stores object information, location information, storage history information, user attribute information, and prompt sentences in structured tables. The server also executes a natural language processing library and a generative AI model implemented using a machine learning framework such as a deep learning framework.

The terminal executes a client application, which can be implemented as a native application or a web browser-based application. The terminal presents a graphical user interface that allows the user to input object information, inquiry sentences, and storage decisions, and to receive and view responses, including storage place proposal sentences, from the server.

The server uses the storage device to maintain a set of data structures including: an object table storing identifiers and basic attributes of managed objects; a location table storing identifiers of physical or digital locations; a storage history table storing associations between objects, locations, and timestamps; a user table storing user identifiers and user attribute information; and a prompt log table storing prompt sentences and associated responses for the generative AI model. Each table is indexed on fields such as object identifier, category, and location identifier to enable efficient retrieval.

The server uses a generative AI model that follows a neural network architecture, for example, a transformer-based sequence model with multiple attention layers. The model receives tokenized text sequences as input and outputs either (i) a probability distribution over predefined categories for classification, or (ii) a sequence of output tokens representing a natural-language sentence. The server uses a tokenizer to convert a prompt sentence into a sequence of subword tokens, maps the tokens to embedding vectors via a learned embedding matrix, and feeds the embeddings into the transformer encoder and/or decoder layers. Each transformer layer performs multi-head self-attention, linear transformations, and non-linear activations, and uses residual connections and layer normalization to stabilize training and inference. The server uses a softmax layer to obtain category probabilities or next-token probabilities.

The server trains the generative AI model offline on a training dataset composed of pairs of input prompt sentences and target outputs. For the classification function, the target output contains ground-truth categories for objects based on their descriptions and attributes. For the proposal function, the target output contains human-authored or curated storage place proposal sentences given historical storage data, categories, and user profiles. The server minimizes a loss function such as a cross-entropy loss between predicted probabilities and target labels. During training, the server updates model weights by backpropagation and a gradient-based optimization algorithm, such as stochastic gradient descent or an adaptive optimizer. The server may apply regularization techniques such as dropout and weight decay, and may perform data augmentation on textual inputs by paraphrasing or synonym substitution to improve generalization.

The server uses a dedicated emotion analysis module, which may be implemented as a separate neural network model or as a component within the same generative AI model. The emotion analysis module receives features derived from the user's inquiry sentences and interaction history. The server extracts features such as token sequences, sentiment scores from a sentiment analyzer, and metadata such as input frequency or correction frequency. The emotion analysis module outputs an emotion state label or a vector representing an estimated affective state. The server uses a loss function specific to emotion classification during training and updates model parameters to improve accuracy.

The server integrates the classification, proposal generation, and emotion analysis in a way that improves computer functionality beyond simple automation of manual tasks. The server uses a unified data flow in which the output of one module is used as structured input to another module via explicit prompt sentences. The server does not simply mirror human rules; instead, it computes internal representations of object descriptions and histories that would be impractical for a human to maintain or update in real time. For example, the server maintains high-dimensional embedding vectors for categories, locations, and users in numerical space, which allows rapid similarity computation and ranking using vector operations on the processor or accelerator hardware.

The server constructs specific prompt sentences that encode not only raw user input but also intermediate structured information generated by the system. For instance, the server may construct a classification prompt sentence such as:
“Classify the following household item into one category: ‘electronics’, ‘stationery’, ‘documents’, ‘kitchenware’, or ‘others’. Item description: ‘new laptop PC, work laptop, 15-inch, mainly used in home office’. Reply with only the category name.”

The server uses this prompt sentence as input to the generative AI model for classification, which allows the same model architecture to process various forms of instructions while reusing weights and optimized computational pathways. This reduces memory footprint and improves cache efficiency compared to deploying separate models for each task.

The server also constructs a proposal prompt sentence that encodes candidate locations and statistical information derived from storage history. For example, the server may construct: “The item category is ‘electronics’. Candidate storage locations with past usage counts are: ‘study room shelf’ (25), ‘living room TV stand’ (10), ‘office cabinet B’ (5). Choose the best single location for efficient storage in a typical home and return only the location name.”

The server thus uses storage history information to pre-filter and rank candidates, and uses the generative AI model to perform a final selection under constraints. Because the server performs ranking using indexed queries and vector operations before calling the generative AI model, the server reduces the computational load on the model and decreases overall processing latency and network bandwidth consumption.

The server further constructs a storage place proposal sentence by generating a prompt sentence such as:

“The user has a new item: ‘new laptop PC’. The category is ‘electronics’. The best storage location is ‘study room shelf’. Generate one polite, concise English sentence recommending this location to the user.”

The server uses the generative AI model to transform this structured information into a natural-language sentence. This process allows the server to separate high-level data representation (categories, counts, locations) from language realization, which in turn improves maintainability and scalability of the system.

The server uses specialized data structures to represent storage history information. For example, the server maintains, for each classification, a list or table of locations annotated with counts, recency scores, and user-specific preference scores. The server periodically or incrementally updates these statistics when new storage decisions are recorded. The server stores aggregated statistics in memory for fast access and also persists them in the storage device. By precomputing and updating such statistics, the server can compute candidate sets and scores using simple arithmetic operations without scanning all history records each time. This structure improves computational complexity and reduces response time.

The server uses the emotion analysis function to modify both the prompt sentences and the final output sentences. For instance, when the emotion state indicates high frustration, the server may include more explanatory context in the prompt sentence and ask the generative AI model to provide a more supportive tone. When the emotion state indicates a neutral or experienced user, the server may generate shorter, more direct responses. The server can construct prompts such as:

“The user seems frustrated based on the last messages. Generate a brief, empathetic explanation of why ‘study room shelf’ is recommended for storing a ‘new laptop PC’, and include one alternative option.”

By embedding emotion-related instructions directly into the prompt sentences, the server exploits the generative AI model's internal representation capabilities to adapt language generation without changing core retrieval algorithms. This is a technical improvement, because it establishes a feedback loop where the server uses emotion state estimation to adjust the text generation process in a programmable and data-driven manner, leading to fewer repeated queries and reduced network traffic.

The server improves data management and computational efficiency by maintaining and using prompt logs and associated outputs. The server records each prompt sentence and the generative AI model's response, together with context information such as the object identifier, user identifier, and outcome (e.g., whether the user accepted the recommendation).

The server analyzes these logs to refine prompt templates and to detect patterns of model errors or user dissatisfaction. The server may automatically adjust weights in ranking functions or modify the phrasing of prompt sentences to reduce ambiguity. This dynamic adaptation results in higher accuracy of classification and recommendation over time, which reduces the need for manual correction and subsequent requests.

The server implements non-conventional processing sequences that differ from typical human rule-based storage advice. For instance, the server can identify subtle correlations between particular object descriptions and rarely used storage locations, learned from data, that humans would not consistently recall. The server applies vector similarity search over learned embeddings of objects and locations to propose locations that are similar to successful past decisions but not simply the most frequent. The server thus performs high-dimensional, non-linear similarity computation in the latent space of the generative AI model, rather than relying on explicit hand-written rules, leading to improved precision and adaptability.

The server may employ alternative embodiments of the generative AI model. In one embodiment, the server uses a single transformer model with a shared encoder and separate output heads for classification and text generation. In another embodiment, the server uses a modular architecture in which a classifier head and a text generator head share lower layers but have distinct higher layers. In yet another embodiment, the server uses two separate models, a classification model and a dialogue model, but coordinates them via a common prompt generation module and shared feature representations stored in memory. Each structure allows trade-offs between model size, computation time, and accuracy.

The server may also vary the storage device configuration. In one embodiment, the server uses a relational database for persistent storage and an in-memory data store for caching frequently accessed statistics and object records. In another embodiment, the server uses a distributed database system that partitions data by user or by category to improve scalability and fault tolerance. In each case, the server uses indexes and optimized query plans to perform rapid retrieval of storage history and to compute candidate locations before invoking the generative AI model.

The terminal presents the results of processing in a manner that reflects the server's decisions. The terminal displays the classification determined by the generative AI model, the primary recommended storage location, alternative candidate locations, and the generated storage place proposal sentence. The terminal may also provide indicators of confidence or explanations, as supplied by the server, to help the user understand the recommendation. The terminal sends the user's accepted or modified storage decision back to the server for inclusion in the storage history.

The user interacts with the system by registering new objects, making inquiries, and confirming or revising storage locations. The user benefits from improved response speed and accuracy because the server uses optimized data structures, precomputed statistics, and a generative AI model optimized for the specific tasks of classification and proposal generation. The user does not need to define or maintain complex rule sets, as the server manages such logic internally through model training and historical data analysis. The described embodiments improve computer technology in several respects. By unifying classification, retrieval, and generation under a common generative AI framework with structured prompt sentences, the server reduces redundancy in model deployment and memory usage. By using indexed storage history and embedding-based similarity computations, the server accelerates the process of ranking candidate storage locations and reduces the computational load on the generative AI model. By integrating emotion analysis into the prompt generation and response generation pipeline, the server reduces unnecessary user interactions and improves effective bandwidth utilization. By logging prompts and outcomes and using them to refine processing, the server improves the precision and robustness of the system over time. These technical effects arise from specific data structures, model architectures, and processing sequences implemented in the server and cannot be achieved merely by automating a human expert's mental process without such computational mechanisms.

Various modifications and alternative implementations are possible. The server may use different types of neural architectures, such as recurrent networks or convolutional networks, for subsets of functions, provided that the overall mechanism of generating structured prompt sentences, using a generative AI model for both classification and proposal generation, and reusing storage history information is maintained. The server may additionally integrate other sensor data, such as image data of objects or locations, and extend the feature vectors used for classification and recommendation. The server may also adjust model parameters or thresholds based on device constraints or user preferences. All such variations are intended to fall within the scope of the disclosed embodiments.

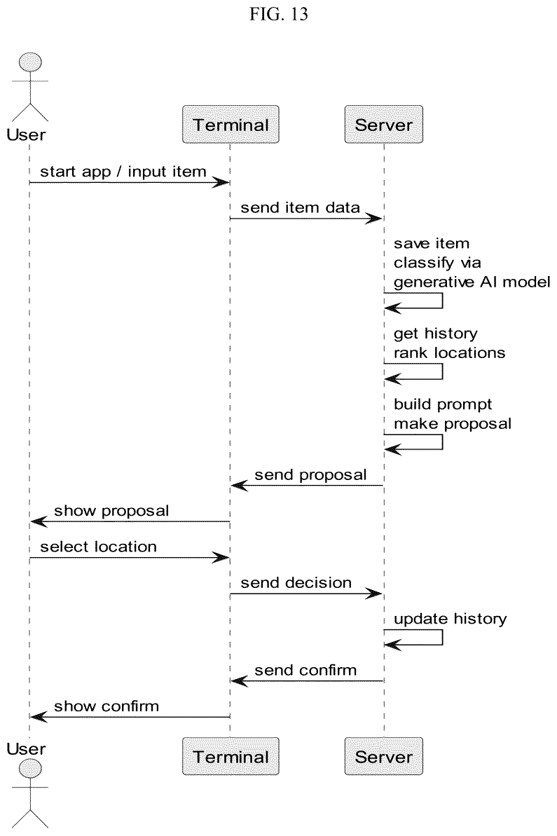

The following describes the processing flow using FIG. 13.

### Step 1:

The user operates the terminal to start an application for object management.

The terminal displays an input screen that includes fields for an object name, an optional description, an optional category hint, and optional attributes such as size or usage frequency.

Input: The user's keystrokes and selections on the terminal UI.

Output: A set of structured input values held in the terminal's memory (for example, object name, description text, category hint, size).

The terminal converts the UI input into a structured internal representation by mapping each field to a corresponding key in a data structure.

### Step 2:

The terminal generates a request message to the server.

The terminal serializes the structured input values into a text-based format and attaches metadata such as a user identifier and a timestamp.

Input: The structured input values from Step 1.

Output: A request message including the object information and metadata, prepared for transmission over a network.

The terminal sends the request message to the server via a communication interface using a network protocol.

### Step 3:

The server receives the request message via its communication interface.

The server passes the raw message data to an application program, which deserializes the message and reconstructs the structured object information.

Input: The request message transmitted from the terminal.

Output: A server-side data structure containing the object name, description, category hint, attributes, user identifier, and timestamp.

The server validates the fields, checks for missing or malformed data, and discards or flags invalid requests.

### Step 4

The server records a new object entry in a storage device.

The server constructs a database command that inserts the object name, description, category hint, attributes, and user identifier into an object table, leaving classification and location fields initially unset or default.

Input: The validated object information from Step 3.

Output: A stored object record with a newly assigned object identifier in the storage device.

The server receives the generated object identifier from the database engine and stores it in working memory for subsequent processing.

### Step 5:

The server prepares a classification prompt sentence for a generative AI model.

The server combines the object name, description, and category hint into a single natural-language string that instructs the model to output one of several predefined categories.

Input: The object name, description, and category hint associated with the object identifier.

Output: A classification prompt sentence in natural-language text form.

The server may append explicit category options and output constraints to the prompt sentence to reduce ambiguity.

### Step 6:

The server converts the classification prompt sentence into model input features.

The server tokenizes the prompt sentence into tokens, converts the tokens into token identifiers, maps the identifiers to embedding vectors, and organizes the vectors into a tensor with a fixed sequence length.

Input: The classification prompt sentence from Step 5.

Output: A tensor representation of the prompt sentence suitable for input to the generative AI model.

The server pads or truncates token sequences as necessary and stores the resulting tensor in a memory buffer accessible to the processor or accelerator.

### Step 7:

The server executes the generative AI model to obtain classification information.

The server feeds the tensor representation into a neural network that includes multiple layers of attention, linear transformations, and non-linear activations, and applies a classification head that generates a probability distribution over category labels.

Input: The input tensor generated in Step 6 and the current model parameters stored in memory.

Output: A probability distribution over predefined categories and a selected category label for the object.

The server performs matrix multiplications, softmax operations, and other numerical computations on the processor or accelerator, and selects the category with the highest probability as the classification information.

### Step 8:

The server records the determined classification information for the object.

The server issues an update command to the storage device to set the classification field for the object identifier based on the selected category label.

Input: The object identifier from Step 4 and the selected category label from Step 7.

Output: An updated object record in the storage device that now includes classification information.

The server may also log the mapping between the prompt sentence, the model output, and the final category selection in a prompt log table.

### Step 9:

The server retrieves storage history information for similar objects.

The server queries a storage history table in the storage device, filtering by the determined classification information and optionally by user identifier or object attributes.

Input: The classification information and the object identifier.

Output: A set of storage history records that include past object identifiers, corresponding locations, timestamps, and usage statistics.

The server aggregates these records in memory to compute usage counts and recency scores for each distinct location.

### Step 10:

The server computes and ranks candidate storage locations.

The server processes the aggregated counts and recency scores using a ranking algorithm that may combine weighted sums or other scoring functions to produce a numerical score for each location.

Input: The aggregated storage history information from Step 9.

Output: An ordered list of candidate storage locations with associated scores.

The server selects the top-ranked locations and stores them in a data structure for subsequent use in prompt generation.

### Step 11:

The server estimates the user's emotion state.

The server analyzes recent inquiry sentences and interaction patterns from the user by extracting textual features and behavioral features such as re-query frequency and correction actions.

Input: One or more recent user inquiry sentences and interaction logs, along with an emotion analysis model or function.

Output: An emotion state label or vector that represents the estimated emotional condition of the user.

The server may pass feature vectors through a dedicated emotion analysis network that outputs discrete emotion categories or continuous affective dimensions.

### Step 12:

The server constructs a proposal prompt sentence that encodes candidate locations, classification information, and emotion-related instructions.

The server converts the ordered list of candidate locations and usage statistics into a textual description and combines it with the classification label and optional emotion-based guidance such as the required tone or level of explanation.

Input: The ranked candidate locations from Step 10, the classification information from Step 8, and the emotion state from Step 11.

Output: A proposal prompt sentence that instructs the generative AI model to select or confirm a best storage location and generate or enable a suitable explanation.

The server structures the prompt sentence to include explicit constraints such as “answer with only one location name” or “include one alternative.”

### Step 13:

The server generates input features for proposal computation in the generative AI model.

The server tokenizes the proposal prompt sentence, maps tokens to identifiers and embeddings, and assembles them into an input tensor formatted for the model's encoder or decoder.

Input: The proposal prompt sentence from Step 12.

Output: An input tensor suitable for proposal-related inference by the generative AI model.

The server may apply different maximum sequence lengths or attention masks compared to those used for classification to adapt to the expected length of the proposal prompt.

### Step 14:

The server executes the generative AI model to compute a recommended storage location and/or a natural-language proposal sentence.

The server processes the input tensor through the generative AI model and obtains either a selected location name, a full explanatory sentence, or both, depending on the model configuration and the prompt instructions.

Input: The proposal input tensor from Step 13 and the model parameters.

Output: A recommended storage location candidate and a generated storage place proposal sentence in natural language.

The server decodes the output token sequence into text and may map the returned location text back to an internal location identifier using a similarity or lookup function.

### Step 15:

The server adjusts the recommendation and proposal sentence based on the emotion state and system policies.

The server may alter the level of detail, include alternative locations, or modify wording templates in response to the emotion state, and may revise or filter the model's raw output accordingly.

Input: The recommended location and proposal sentence generated in Step 14, together with the emotion state from Step 11 and any policy settings.

Output: A finalized recommended location identifier and a refined proposal sentence that is suitable for presentation to the user.

The server may add brief explanations or confidence indicators when the user appears uncertain or frustrated.

### Step 16:

The server generates a response message to the terminal.

The server assembles the object identifier, classification information, finalized recommended location, and proposal sentence into a structured data package for transmission.

Input: The finalized recommendation and classification data from Steps 8 and 15.

Output: A response message that encodes the computed category, recommended storage location, alternative locations if applicable, and the proposal sentence.

The server sends the response message to the terminal via the communication interface.

### Step 17:

The terminal receives and interprets the response message.

The terminal deserializes the message and extracts the classification label, recommended location, and proposal sentence into UI-relevant data structures.

Input: The response message sent by the server in Step 16.

Output: UI configuration data including text strings and location identifiers to be shown in the user interface.

The terminal prepares display elements such as labels, buttons, and lists based on the received data.

### Step 18:

The terminal presents the recommendation to the user.

The terminal displays the detected category, the recommended storage location, any alternative locations, and the storage place proposal sentence on the screen.

Input: The UI configuration data from Step 17.

Output: Visual and/or audio output presented to the user that conveys the recommendation and an explanation.

The terminal may also highlight interactive controls for accepting or modifying the recommendation.

### Step 19:

The user reviews and responds to the recommendation.

The user reads or listens to the proposal sentence, then chooses to accept the suggested storage location, select one of the alternative locations, or input a custom location.

Input: The displayed recommendation and proposal sentence from Step 18.

Output: A user decision, which may take the form of a selection of a location or an entry of a new location name.

The user confirms the decision by activating a UI control, such as pressing a confirmation button.

### Step 20:

The terminal generates a storage decision message.

The terminal captures the user's selected or entered location, associates it with the object identifier, and bundles this together with any additional metadata such as a timestamp.

Input: The user's decision captured in Step 19.

Output: A storage decision message addressed to the server, containing the object identifier, chosen location, and decision flags (e.g., accepted or modified).

The terminal transmits this message to the server through the communication interface.

### Step 21:

The server receives and processes the storage decision.

The server deserializes the storage decision message and extracts the object identifier, chosen location, and decision flags.

Input: The storage decision message from Step 20.

Output: Parsed decision data stored temporarily in server memory for updating the storage history.

The server may validate that the chosen location exists in the location table or, if it is new, create a new location entry.

### Step 22:

The server updates the storage history and current location information.

The server writes a new entry into the storage history table that associates the object identifier with the chosen location, classification information, user identifier, and timestamp, and updates the current location field of the object record.

Input: The parsed decision data from Step 21 and the classification information from Step 8.

Output: Updated records in the storage history table and object table reflecting the new storage event.

The server also updates location usage counts, recency statistics, and user-specific preference values in auxiliary tables or cached data structures.

### Step 23:

The server confirms completion of the update to the terminal.

The server generates a confirmation message indicating that the storage decision has been recorded and may optionally include the stored location name and any relevant notes.

Input: The successful database update results from Step 22.

Output: A confirmation message delivered to the terminal.

The server transmits this message to the terminal using the communication interface.

### Step 24:

The terminal presents the confirmation to the user.

The terminal displays a short message indicating that the object has been registered as stored at the chosen location and that future retrievals will refer to this location.

Input: The confirmation message from Step 23.

Output: A confirmation screen or notification presented to the user.

The terminal may allow the user to close the message or proceed to other operations, such as registering another object or performing a search.

### Step 25:

The server reuses accumulated storage history and prompt logs in subsequent processing.

The server periodically analyzes stored history records and prompt logs to adjust ranking parameters, update prompt templates, and refine model usage patterns.

Input: The accumulated storage history information and prompt-response pairs recorded over multiple sessions.

Output: Updated scoring weights, modified prompt templates, and, optionally, retraining or fine-tuning data for the generative AI model.

The server uses these updated elements in future classification and proposal steps to improve accuracy, reduce response time, and lower the number of user corrections required.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional item-location management systems and recommendation systems suffer from several technical limitations in how they process and utilize user input, historical storage data, and user context. First, typical systems store item location information in a simple key-value structure and perform direct lookup without dynamically restructuring data or behavior based on user queries expressed in natural language. As a result, such systems often require rigid query formats, leading to increased parsing overhead on the client side and frequent mismatches between a user's natural language intent and the system's internal data representation.

Second, existing systems generally do not integrate past storage history data into a unified decision-making pipeline that also includes real-time user feedback about actual placement results. Historical data, if used at all, is typically accessed through static business rules or fixed heuristics. This limits the system's ability to adaptively refine future suggestions and fails to leverage modern generative models that can infer nuanced relationships between item classes, storage locations, and context constraints.

Third, known systems rarely treat user emotional state as a first-class input signal inside the core retrieval and recommendation pipeline. Emotion recognition, when used, is often loosely coupled to the system as a peripheral feature, for example, only adjusting UI style or tone. In such systems, the underlying information retrieval components and location suggestion logic remain unchanged regardless of the user's emotional state. Consequently, the system cannot modify ranking strategies, response structure, or prompt content in a technically meaningful way to optimize interaction flows, reduce repeated queries, or lower overall processing cost.

Fourth, current uses of generative AI models in item-location systems are typically limited to post-processing, such as stylistic rephrasing of responses. Existing architectures often send raw query text to a generative model, receive a response, and then separately perform database retrieval and logic on a conventional stack. This separation prevents the generative model from being used as a programmable orchestrator of retrieval and proposal steps through carefully structured prompt sentences that carry both historical data summaries and system constraints. As a result, such systems cannot fully exploit the generative model's capability to unify natural language understanding, context fusion, and proposal generation within a single, optimized interaction loop.

Accordingly, there is a need for a computer-implemented technique that improves the way a server: (i) interprets and structures user inquiries in natural language, (ii) fuses classification information and past storage history with user emotion state, (iii) generates machine-targeted prompt sentences for a generative AI model, and (iv) feeds back placement result information into the data store. Such a technique should improve technical performance by reducing misinterpretations of user intent, lowering the number of server round-trips needed to obtain a satisfactory answer, enabling more efficient use of storage history data, and providing a configurable mechanism to adapt retrieval and proposal algorithms at runtime, thereby improving the overall functioning of the computer system itself rather than merely producing different human-facing content.

The specific processing by the specific processing unit 290 of the data processing device 12 in Application Example 2 is realized by the following means.

The present invention provides a server comprising a processor and a storage device, the processor being configured to (i) receive input from a user and, based on the input, store item location information in the storage device as structured location information including physical and digital storage positions, (ii) analyze an inquiry from the user using a natural language processing technique to produce a normalized internal representation of user intent, (iii) retrieve, based on the normalized intent, corresponding item location information and past storage history data from the storage device, (iv) obtain classification information for an item by processing item-related image information or other item descriptors, (v) generate, on the server side, machine-targeted prompt sentences that embed at least the normalized user intent, the classification information, and a condensed summary of the past storage history data, (vi) input the prompt sentences into a generative AI model and obtain, as model output, proposal content for storage locations and natural language answers, (vii) analyze a user emotional state by means of an emotion analysis mechanism and programmatically adjust at least one of retrieval behavior, ranking of candidate storage locations, and the content of the prompt sentences based on the emotional state, and (viii) receive placement result information indicating an actual placement of an item from the user and append the placement result information to the past storage history data in the storage device as feedback for subsequent processing. This enables the server to technically improve the functioning of the item-location management system by dynamically orchestrating database retrieval, emotion-aware adaptation, and generative model interaction through structured prompt sentences, thereby reducing query-response mismatches, minimizing repeated user interactions, and continuously refining internal data structures and recommendation logic based on real-world placement feedback.

The term “processor” refers to a hardware or virtual computation unit, such as a central processing unit or a processing core, that executes instructions to perform logical operations, data processing, and control of system components.

The term “storage device” refers to a hardware or virtual storage resource, such as a memory device or a database system, that persistently or semi-persistently stores data including item location information, past storage history data, and placement result information.

The term “user” refers to a human operator or an automated client that provides input to the system, issues inquiries, and receives responses or proposals regarding item locations.

The term “item” refers to any physical object or digital object for which location information is managed by the system, including but not limited to goods, documents, files, or content objects.

The term “item location information” refers to structured data that specifies where an item is stored, including identifiers or descriptors of physical storage places, digital storage places, or both.

The term “physical storage place” refers to a real-world storage position, such as a shelf, drawer, aisle, room, or zone, that can physically hold an item.

The term “digital storage place” refers to a logical or virtual storage position in an information processing environment, such as a directory, folder, database record, or resource locator associated with a digital item.

The term “input from a user” refers to any data or command provided by the user to the system through an interface, including item identifiers, queries in natural language, image data, feedback, or placement confirmations.

The term “inquiry from the user” refers to a user-provided request expressed in natural language or structured form, by which the user asks the system for information about item locations, proposals, or related content.

The term “natural language processing technique” refers to a software-implemented method that analyzes text or speech data to extract intent, entities, or semantic information, including but not limited to tokenization, parsing, classification, and intent recognition.

The term “normalized internal representation of user intent” refers to a structured data format derived from a natural language inquiry that encodes the semantic intent, target items, and constraints in a machine-interpretable form.

The term “past storage history data” refers to accumulated records describing previous storage or placement of items, including categories, storage places, timestamps, performance indicators, and related metadata.

The term “classification information” refers to data indicating a category, type, or class to which an item belongs, derived from image analysis, item descriptors, or other input features.

The term “image information” refers to visual data associated with an item, such as still images or video frames, that is used by the system to infer properties or classification of the item.

The term “terminal device” refers to an end-user computation device, such as a mobile device, wearable device, or client computer, that captures user input or image information and communicates with the server.

The term “proposal content” refers to data representing a suggested storage location or arrangement for an item, including descriptions in natural language and, optionally, structured identifiers of storage places.

The term “prompt sentence” refers to a text sequence generated by the server and provided as input to a generative AI model, the text sequence encoding instructions, context, and data summaries to guide generation of proposal content or answers.

The term “generative AI model” refers to a machine learning model, such as a language model, configured to generate text or other content in response to input prompts based on learned parameters.

The term “answer in natural language” refers to a text response generated by the generative AI model in a human-readable language, describing item locations, proposals, or explanations.

The term “emotion analysis mechanism” refers to a software-implemented or hardware-assisted component that estimates a user's emotional state based on input signals such as text content, voice characteristics, facial expressions, or interaction patterns.

The term “emotional state of the user” refers to an estimated psychological condition of the user, such as stress, calmness, satisfaction, or frustration, represented as data used by the system to adjust its processing.

The term “provision content of the item location information” refers to the specific form, detail level, and presentation structure in which the system provides item location information back to the user.

The term “placement result information” refers to data describing an actual storage or placement action performed for an item by the user, including the determined storage place, time of placement, and any associated status information.

The term “append the placement result information” refers to an operation that adds new placement result records to the existing past storage history data stored in the storage device without discarding prior records.

The term “display device for the user” refers to any output interface, such as a screen, headset display, or graphical user interface component, that presents proposal content or answers to the user.

The term “retrieval behavior” refers to the internal processing strategy by which the processor searches, filters, ranks, or aggregates records from the storage device in response to a user inquiry or system request.

The term “ranking of candidate storage locations” refers to an ordered evaluation of possible storage places for an item, based on criteria including past performance, context, classification, and emotional state, used to select or prioritize proposals.

The term “machine-targeted prompt sentence” refers to a prompt sentence structured specifically for consumption by the generative AI model, embedding technical details such as identifiers, summaries, and constraints in a way that optimizes model behavior.

In one embodiment, a server, a plurality of terminals, and at least one user cooperate to implement the claimed system. The server includes a processor, a main memory, a non-volatile storage device, and a network interface, and executes software components including a web application framework, a database management system, a natural language processing module, an image recognition module, an emotion analysis module, and a generative AI interaction module. The terminals include, for example, smartphones, tablet devices, wearable devices such as smart glasses, and personal computers, each having at least one processor, a memory, a camera, a microphone, a display device, and a communication interface.

Server executes a database management system such as a relational database engine on the storage device. Server manages tables that store item records, item location information, past storage history data, user profiles, emotion history, and model interaction logs. Server defines item location information as a structured record including: an item identifier, a category identifier, a physical storage place identifier (for example, aisle, shelf, compartment), a digital storage place identifier (for example, folder path, resource locator), timestamps, and quality metrics such as retrieval success rate or user-confirmed correctness.

Server executes a natural language processing module that runs on a software library stack such as a tokenization engine, a part-of-speech tagger, a dependency parser, and an intent classifier. Server defines custom data structures to store token sequences, parse trees, and intent slots. Server uses these internal data structures to transform an inquiry text from a user into a normalized internal representation of user intent, which identifies target item names or categories, requested operation types (for example, “locate”, “suggest storage”), and constraints (for example, “near desk”, “easy to access”).

Terminal operates a client-side application that presents user interfaces for input and display. Terminal uses the camera to acquire image information of an item and sends compressed image data together with metadata such as tentative item name, preliminary category indicated by the user, and device position information to the server. Terminal uses the microphone and text input fields to capture user inquiries and emotion-related input. Terminal encodes these data streams into structured messages and transmits them to the server using secure communication protocols.

Server executes an image recognition module built on general-purpose image-processing software, including a convolutional neural network implemented on a deep learning framework. Server loads a trained neural network model, which in one example is a multi-layer convolutional architecture including convolution layers, pooling layers, batch normalization layers, rectified-linear activation functions, and fully connected layers, followed by a softmax output layer that outputs a probability distribution over pre-defined item categories. Server converts the image information received from the terminal into pixel tensors, normalizes the pixel values, and feeds the tensors into this neural network. Server obtains classification information such as a category label “stationery”, “electronic device”, or “document” together with confidence scores. Server then stores the classification information in the database together with the item identifier and image metadata.

Server executes an emotion analysis module that uses either textual features, audio features, or facial image features. Server constructs feature vectors derived from user messages. For text, server uses token frequency, sentiment scores, and semantic embeddings. For voice, server extracts prosodic features such as pitch, energy, and speaking rate. For facial images, server uses a separate neural network to output emotion probabilities. Server aggregates these features and inputs them into a classifier, such as a multi-layer perceptron or recurrent neural network, trained with supervised learning to map feature vectors to discrete emotional states (for example, “stressed”, “calm”, “frustrated”, “enthusiastic”) or to continuous valence-arousal values. Server stores the resulting emotional state as emotion data associated with the user and the corresponding inquiry.

Server executes a generative AI interaction module to communicate with an external or internal generative AI model that performs large-scale language generation. Server is configured to not simply forward raw user text, but instead to construct explicit prompt sentences that embed machine-targeted instructions, summarized database content, emotion state, and classification results. Server maintains a prompt composition rule set that specifies how to assemble a prompt sentence from internal fields. For example, server combines: (i) a role description directing the generative AI model to behave as a storage optimization assistant, (ii) the normalized user intent, (iii) a textual summary of past storage history data derived from database aggregations, (iv) current emotion state of the user, and (v) system constraints such as limited shelf capacity.

Server first computes summaries of past storage history for an item category by executing analytical queries over the database, such as grouping by physical storage places and ranking according to success metrics. Server transforms numerical results into human-readable summary text using deterministic templates. Server then inserts this summary text into a prompt sentence. Example prompt sentences include:

“You are a storage optimization assistant in a physical and digital environment.

User intent: locate a file named ‘report.docx’.

Past storage history: similar documents have been successfully stored in the ‘Project A’ folder and retrieved quickly from that folder.

User emotional state: the user is stressed and prefers quick access.

Based on this information, propose the best digital storage location and explain briefly why, in English.”

“You are a household item placement advisor.

Item category: stationery (notebook).

Past storage data: stationery items have often been stored in the living room drawer and on the left side of the office shelf, with higher retrieval success from the living room drawer.

User emotional state: the user is frustrated and needs very easy access.

Based on this information, propose the optimal storage place for the notebook in one or two sentences.”

Server sends such prompt sentences to the generative AI model via a programmatic interface. Server defines configuration parameters such as maximum output length, randomness control (for example, temperature), and safety filters. Server receives the generated answer from the model, which may contain one or more candidate storage proposals and descriptive explanations. Server then post-processes the answer to extract structured elements, such as specific shelf identifiers or folder paths, using pattern matching or secondary light-weight parsing. Server writes these structured proposals into database structures so that the proposals can be used as candidate storage locations, logged, and evaluated in future sessions. Server arranges the internal modules in a pipeline architecture. A request from a terminal triggers sequential execution of modules: the natural language processing module, the image recognition module when item images are present, the database retrieval and summary module, the emotion analysis module, and the generative AI interaction module. Server maintains intermediate representations in memory as typed data objects rather than free-form text. This architecture reduces redundant parsing operations and allows the system to reuse intermediate results across multiple related requests, improving computation efficiency and reducing network traffic between internal components.

Server improves computer technology in at least the following ways. First, by generating machine-targeted prompt sentences that embed preprocessed summaries and structured constraints, server reduces the token length and ambiguity of interactions with the generative AI model. This reduces computation time on the generative AI model side and lowers the communication load between server and the model endpoint. Second, by incorporating classification information and past storage history directly into the prompt structure, server reduces the number of round-trip interactions required to obtain a correct and useful answer, which shortens latency as experienced by the user. Third, by adjusting both database retrieval behavior and prompt content based on emotion state, server dynamically modifies ranking and filtering criteria in a way that is not achievable by static rule-based systems. This reduces misaligned answers and the need for users to refine queries manually, thereby lowering server-side processing burden.

Server uses a specific neural network architecture for classification and emotion analysis, and relies on explicit loss functions and training regimes. For example, server trains the item classification network using cross-entropy loss over labeled item images. Server uses stochastic gradient descent or a variant with momentum and adaptive learning rate to update weights. Server optionally applies data augmentation techniques such as random cropping, flipping, color jitter, or rotation to improve generalization on item appearance variation. For emotion analysis from text, server can deploy a sequence model such as a bidirectional recurrent network or a transformer-based encoder, trained to predict sentiment labels or fine-grained emotion categories. Server logs training metadata into the storage device to allow model version management and performance monitoring.

Server structures past storage history data as a time-series table with composite indices on item category, storage place, and timestamp. Server uses these indices to efficiently compute frequency counts, retrieval success rates, and temporal trends. Server then converts these statistics into summary segments that are incorporated into prompt sentences. Because server processes storage history into compact descriptive forms before sending information to the generative model, the system avoids transmitting raw large datasets. This design significantly reduces the amount of data transmitted to the generative AI model and reduces the need for the generative AI model to perform heavy aggregation work that is more efficiently executed by the database engine.

Terminal interacts with the user to reflect proposals produced by the server. Terminal displays both natural language answers and, when available, structured indicators such as highlighted storage locations on a map, file path representations in a file manager, or augmented reality overlays showing where to place physical items. Terminal may also display alternative suggestions or explanations, and can collect user feedback or confirmation. When the user follows a storage suggestion, terminal records the actual location selected and sends this placement result information back to the server. This feedback closes a learning loop that allows server to enrich the past storage history data and to recalibrate summary texts and prompt sentences in subsequent interactions.

User behaves differently depending on use cases. In one use case, the user manages physical goods in a retail environment. The user holds an item in front of a terminal camera, receives a suggested shelf and aisle from the system, and then physically places the item. In another use case, the user organizes digital documents. The user saves files to folders and confirms recommended locations, while the system learns which folder structures lead to efficient retrieval. In each use case, the feedback from user actions is captured as concrete placement result information that server uses to update the storage history data and thus the future prompt sentences.

Server implements alternative embodiments for communication with the generative AI model. In one variant, server interacts with an external model via an application programming interface. In another variant, server executes a local generative language model on specialized hardware such as a graphics processing unit or tensor processing accelerator installed in the server. In the local model variant, server loads the model parameters into memory and uses a custom inference engine to perform generation. Server can adjust model parameters such as decoding strategy, beam width, or nucleus sampling threshold to achieve a balance between diversity and determinism of proposals.

Server can be configured to work in purely physical-storage contexts, purely digital-storage contexts, or mixed contexts where items may exist both as physical objects and associated digital records. In a purely physical context, server emphasizes mapping item categories to shelves, rooms, and zones, and may integrate with indoor positioning hardware to refine location identifiers. In a purely digital context, server manages relationships between files, repositories, and user-defined taxonomies, and suggests digital storage locations that minimize average retrieval time. In mixed contexts, server correlates physical and digital locations, such as linking physical binders to digital folder hierarchies.

Server improves computer technology beyond mere automation of human tasks by designing specific data structures and control flows that are adapted to generative AI models and emotion-aware retrieval. Server does not simply mimic human decision rules; instead, server orchestrates different algorithmic components in a non-conventional manner. For example, server uses emotion state not to change user interface decoration but to modify internal ranking scores for candidate storage locations and to change prompt emphasis within the prompt sentence. When the emotion analysis module detects stress, server preferentially selects storage places with historically low retrieval time and high success rate, and explicitly instructs the generative AI model, in the prompt sentence, to prioritize easy access over other factors. This machine-targeted adaptation reduces the expected number of follow-up queries and lowers the load on both network and processing resources.

Server further improves reliability and accuracy by logging and comparing generative responses against actual placement outcomes. Over time, server builds an evaluation dataset that includes the proposed storage place, the chosen actual place, and subsequent retrieval success. Server can use this dataset to re-weight statistics in the past storage history table, giving greater weight to suggestions that were both adopted and successful, and down-weighting frequently ignored or ineffective suggestions. Server then uses these updated statistics to form new summaries for future prompt sentences, closing a feedback loop that gradually improves the relevance and precision of recommendations.

In another embodiment, server supports multiple generative AI models and can select among them depending on context. Server may use a lighter-weight model for routine queries that require simple restatements or lookups, and a larger, more capable model for complex, multi-constraint requests involving conflicting objectives such as accessibility versus security. Server encodes the selection logic as a set of rules or a learned policy, and includes model-selection hints in the prompt or routing layer. This architecture further optimizes computational efficiency and latency.

Server can also adjust data pre-processing methods for the generative AI model. For example, server can compress long storage history sequences into clustering-based prototypes or sample representative cases and generate concise descriptions of those cases. By doing so, server reduces the dimensionality and volume of information passed to the model while preserving salient patterns. This improves inference speed and reduces the risk of prompt overfitting or confusion due to noisy details.

Through combinations of these modules and variants, the embodiments described herein enable other practitioners to implement the claimed system on standard computing platforms. Server, terminal, and user roles are clearly separated yet tightly coordinated through the described data structures, algorithmic flows, and generative AI prompt sentence strategies. The technical contributions lie in how server constructs and uses prompt sentences as an internal control mechanism for a generative AI model, how server couples that mechanism to structured database operations and emotion-aware ranking, and how server uses feedback from user-confirmed placement results to dynamically improve subsequent computation.

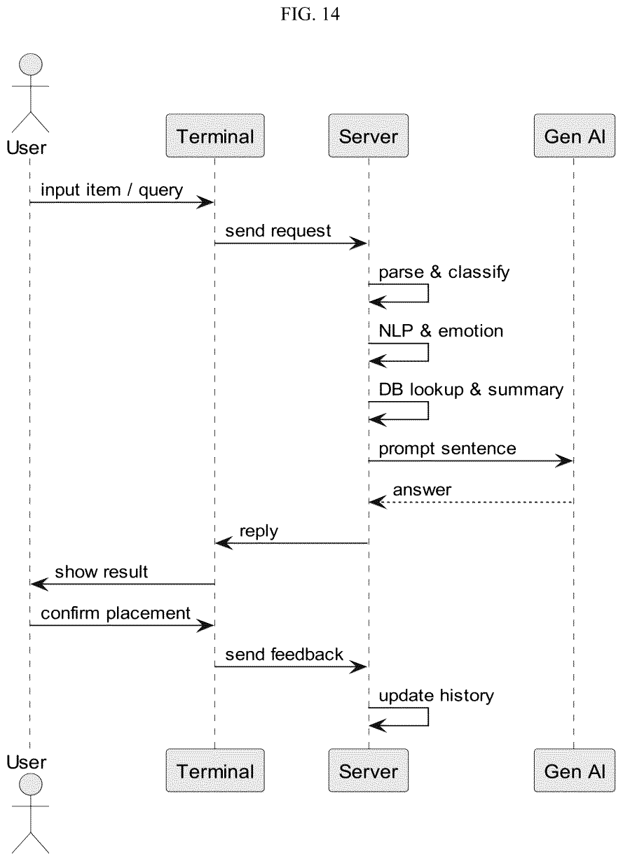

The following describes the processing flow using FIG. 14.

### Step 1:

User provides item-related input.

User selects an item to be managed and provides input to a terminal. As input, user may enter a textual description of the item (for example, “A5 notebook” or “report.docx”), optionally select or type a category, and, in some cases, present the physical item in front of a camera of the terminal. The output of this step is a set of raw input signals including text strings, possible preliminary category labels, and, when applicable, one or more captured images of the item.

### Step 2:

Terminal captures and packages input data.

Terminal receives the raw input signals from the user interface. As input, terminal obtains the item description text, optional preliminary category, captured image frames, and device metadata such as device ID and timestamp. Terminal converts the image frames into compressed image data (for example, JPEG), normalizes text encodings (for example, UTF-8), and builds a structured request object containing these fields. Terminal then outputs a communication payload that encapsulates the normalized text, the compressed image data, and metadata for transmission to the server.

### Step 3:

Terminal transmits the request to the server.

Terminal takes the structured communication payload as input and opens a secure network connection to the server via a communication interface. Terminal performs data serialization into a format such as JSON or multipart form data and attaches the serialized content to an HTTP request. Terminal sends this request to a designated endpoint on the server and outputs the transmitted request as network traffic directed to the server.

### Step 4:

Server receives and parses the request.

Server takes the network request as input through a network interface. Server invokes a web application framework to parse HTTP headers and body, verifying content type, payload size, and basic integrity. Server decomposes the payload into separate entities: item description text, optional preliminary category, image data, and metadata, storing each in working memory. The output of this step is a set of internal data structures holding parsed text, images, and contextual information ready for further processing.

### Step 5:

Server performs image-based item classification.

Server uses the parsed image data as input, when available, and decodes each image into pixel arrays. Server applies preprocessing operations such as resizing, normalization, and color space conversion. Server feeds the preprocessed pixel arrays into a convolutional neural network configured as a classifier. This network performs a series of convolutions, pooling operations, and dense layer computations, yielding a probability vector over predefined item categories. Server selects the category with the highest probability and forms classification information including a category label and confidence score. The output is a structured classification record that will be associated with the item.

### Step 6:

Server analyzes the user inquiry via natural language processing.

Server takes the item description text and any explicit user inquiry as input. Server tokenizes the text, assigns part-of-speech tags, and constructs a syntactic parse representation using a natural language processing library. Server then maps the parsed representation into a normalized intent structure containing fields such as requested action (for example, “locate”, “suggest storage”), target item identifiers, and additional constraints. Server may compute semantic embeddings and similarity scores to match names against known item records. The output is a normalized internal representation of the user intent.

### Step 7:

Server analyzes the user's emotional state.

Server takes as input at least one of: the textual content of the inquiry, voice features if a voice channel is used, or facial image data if the user's face is captured. Server extracts features such as sentiment scores, prosodic attributes, or facial expression embeddings. Server feeds these feature vectors into an emotion classification model, which computes probability scores for multiple emotion categories or continuous emotion dimensions. Server selects the predominant emotion state or numerical profile and stores it as the user's emotional state. The output is a structured emotion record, including labels such as “stressed” or “calm” and associated confidence values.

### Step 8:

Server retrieves item location and past storage history data.

Server takes the normalized user intent and the item classification information as input.

Server generates database queries that filter records based on item identifiers, item categories, and prior storage events. Server executes these queries on a relational database engine and receives result sets describing current known locations and past storage history, including fields such as physical places, digital paths, timestamps, and retrieval success indicators. Server may compute aggregate statistics such as frequency counts and average retrieval time. The output is a collection of current location data and summarized past storage history data. Step 9:

Server generates a textual summary of past storage history.

Server takes the past storage history data as input. Server groups records by storage place and calculates metrics such as usage frequency and success rate. Server then applies deterministic templates to convert these numerical results into compact natural language statements, for example, “similar documents have been successfully stored in the ‘Project A’ folder and retrieved quickly from that folder.” Server concatenates or selects several such statements to form a coherent summary text. The output is a human-readable summary description of storage patterns for use in prompt construction.

### Step 10:

Server constructs a prompt sentence for the generative AI model.

Server uses as input the normalized user intent, the classification information, the emotional state, and the textual summary of past storage history. Server consults a prompt composition rule set that defines a template specifying a role description for the generative AI model, insertion points for the intent, summary, and emotion description, and instructions on output style. Server fills the template with the corresponding values to create a complete prompt sentence. For example, server may generate the following prompt sentence:

“You are a storage optimization assistant in a physical and digital environment.

User intent: locate a file named ‘report.docx’.

Past storage history: similar documents have been successfully stored in the ‘Project A’ folder and retrieved quickly from that folder.

User emotional state: the user is stressed and prefers quick access.

Based on this information, propose the best digital storage location and explain briefly why, in English.”

The output is a finalized prompt sentence ready to be sent to the generative AI model.

### Step 11:

Server sends the prompt sentence to the generative AI model and receives a response.

Server takes the constructed prompt sentence and model configuration parameters as input.

Server serializes these into a request object and sends the request to a generative AI model endpoint, either external or internal. The generative AI model performs internal language generation computations based on its trained parameters and returns a text output. Server receives the response text, checks for completeness, and extracts the main answer section. The output of this step is a generated answer in natural language, containing at least one proposed storage location and potentially an explanation.

### Step 12:

Server post-processes the generative AI model output.

Server takes the generated answer text as input. Server applies parsing rules or regular expressions to identify structured components such as folder names, aisle identifiers, shelf levels, or other location descriptors. Server maps these extracted components to internal identifiers used in the database, verifying consistency and discarding ambiguous phrases when needed. Server combines the structured elements with the original answer text to form a proposal record that includes both machine-readable fields and human-readable explanation. The output is a structured proposal content object representing the recommended storage place.

### Step 13:

Server adjusts proposal content and retrieval behavior based on emotional state.

Server uses the proposal content object and the emotional state record as input. Server evaluates whether the suggested locations satisfy emotion-based criteria, such as ease of access or reduced retrieval complexity for a stressed user. If necessary, server modifies ranking scores of candidate locations or requests an additional refinement interaction with the generative AI model by composing an updated prompt sentence emphasizing specific constraints. Server outputs a finalized proposal content object that has been adjusted in accordance with the user's emotional state and system-defined criteria.

### Step 14:

Server compiles response data and sends it to the terminal.

Server takes as input the finalized proposal content object, any known current location information, and auxiliary explanation text. Server bundles these into a response message that includes the natural language answer, structured identifiers for the recommended location, and any alternative suggestions. Server serializes the response into a machine-readable format and returns it to the terminal through the established network connection. The output is a response payload delivered to the terminal.

### Step 15:

Terminal interprets and displays the response.

Terminal receives the response payload as input. Terminal parses the message, extracting the answer text and structured location identifiers. Terminal renders the answer text on a display and may convert structured identifiers into graphical or navigational elements, such as highlighting a folder in a file manager or indicating a physical shelf on a map or through augmented reality overlays. The output is a user-facing display that communicates the proposed storage location and related information.

### Step 16:

User acts on the proposal and optionally confirms placement.

User observes the displayed proposal as input and decides how to act. For a physical item, user moves to the suggested physical storage place and positions the item accordingly. For a digital item, user moves or saves the file to the suggested digital location. User may then operate a confirmation control on the terminal, such as a “placement completed” button, or provide corrective feedback specifying a different chosen location. The output from this step is a user-generated confirmation or correction message along with implicit or explicit information about the actual storage place used.

### Step 17:

Terminal sends placement result information to the server.

Terminal takes the user's confirmation or correction input as well as the chosen storage place as input. Terminal constructs a placement result object containing the item identifier, the recommended location, the actual location selected by the user, and a timestamp. Terminal serializes this object and sends it to the server via the communication interface. The output is a placement result message delivered to the server.

### Step 18:

Server updates past storage history data with feedback.

Server takes the placement result message as input. Server writes a new record into the past storage history table, including fields for item category, proposed location, actual location, and, if available, an indication of whether the user followed the recommendation. Server may update aggregated statistics, such as success counts and retrieval measures, based on this new record. Server outputs an updated state of the storage history database and logs, which will be used as input in future iterations for summary generation and prompt sentence construction.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

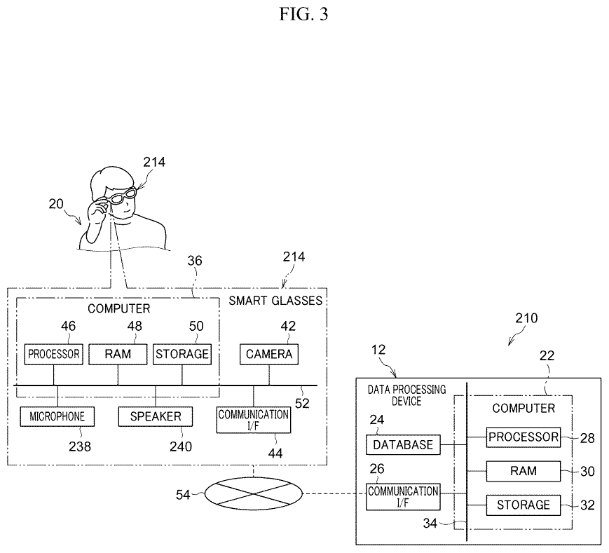

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

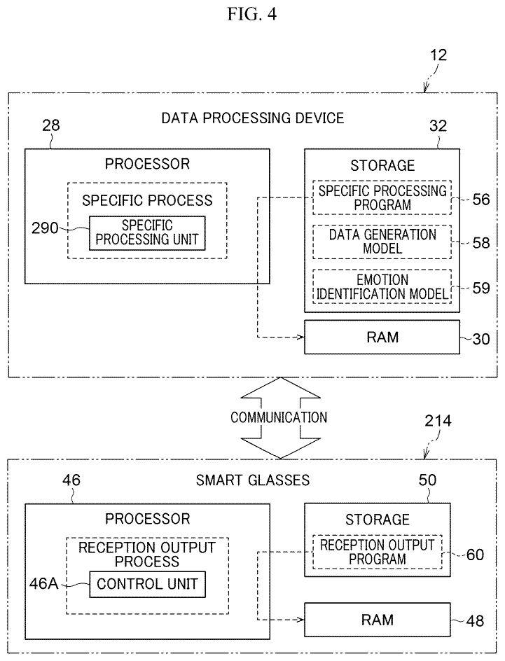

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

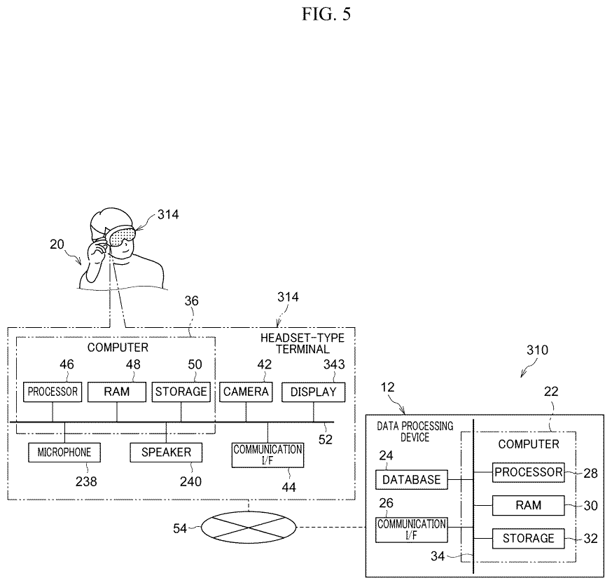

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

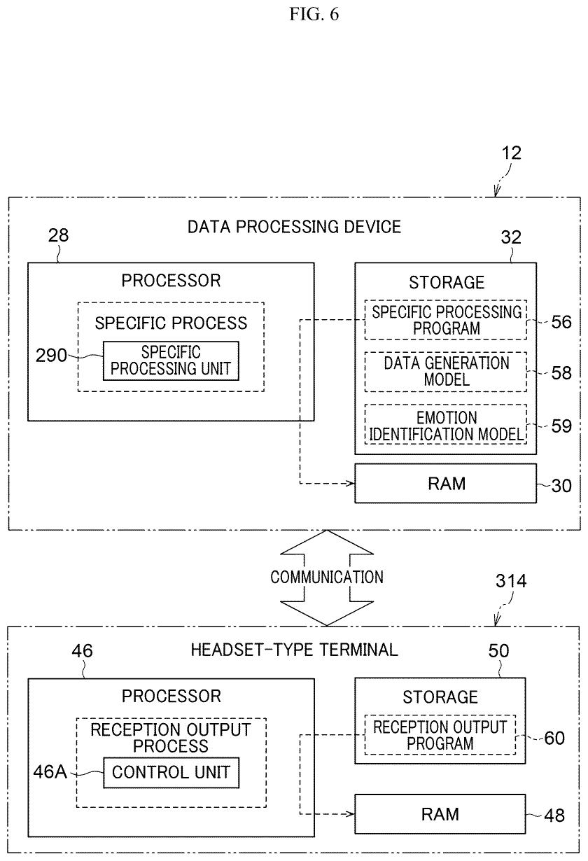

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

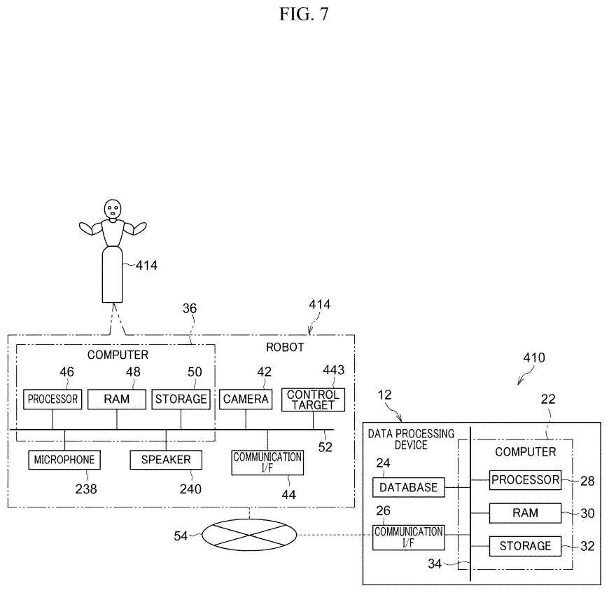

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

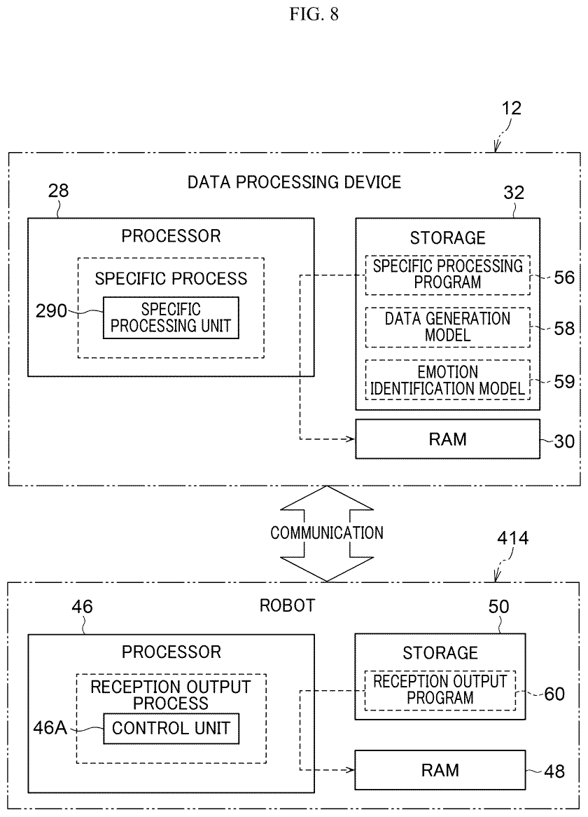

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

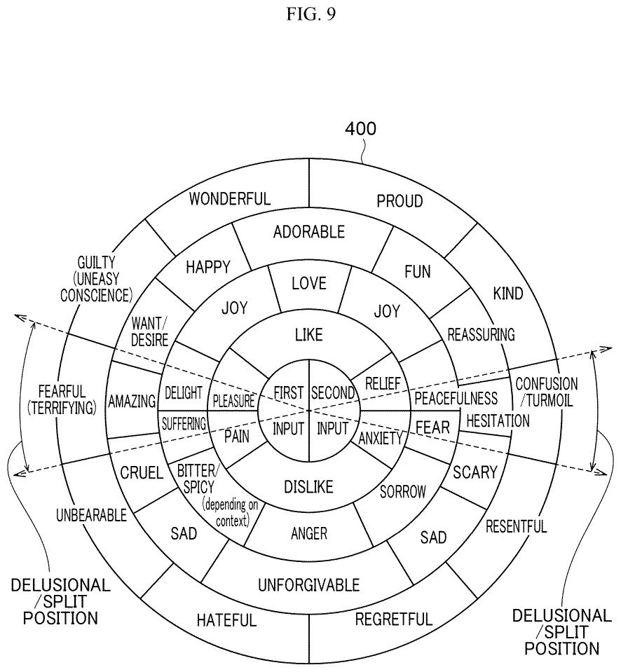

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

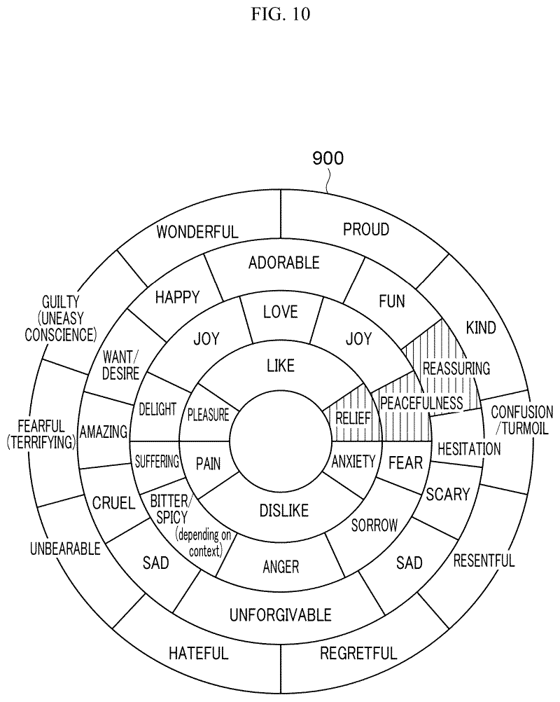

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive item identification information and storage location information from a user terminal and store, via a write operation to a database management program operating on a general-purpose information processing apparatus, the item identification information and the storage location information as location information indicating an association between an item and a storage location,
generate an analysis prompt sentence for presentation of a natural-language inquiry sentence, received from the user terminal, to a generative AI model having a natural language processing function, and execute an inference operation of the generative AI model using the analysis prompt sentence so as to extract, from the inquiry sentence, keyword information or intent information for identifying the item,
execute a search operation on the database management program based on the extracted keyword information or intent information, and acquire, as a search result, the location information stored in association with the item identification information,
generate a response-generation prompt sentence including the acquired location information and the inquiry sentence, present the response-generation prompt sentence to the generative AI model so as to cause the generative AI model to generate a natural-language answer sentence, and transmit the generated answer sentence to the user terminal,
derive, by arithmetic processing based on past storage history data, a candidate storage location for an item having the same or similar attribute as the item corresponding to the extracted keyword information or the item identification information, and output, to the user terminal, proposal information including the candidate storage location,
and analyze a user emotional state from operation information or utterance information of a user by using an emotion analysis function, generate control information for adjusting, according to the user emotional state, at least one of an expression content of the analysis prompt sentence, an expression content of the response-generation prompt sentence, and an expression content of the answer sentence, and change, by using the control information, a presentation mode of an analysis result and an answer result produced by the generative AI model.

### (Supplementary 2)

The system according to supplementary 1,
wherein the processor is configured to cause the database management program to record the location information in a data structure capable of storing information indicating at least one of a physical storage location and a digital storage location, and to record, as the location information, information including a storage region of a physical storage medium and a storage region of an electronic information recording medium.

### (Supplementary 3)

The system according to supplementary 1,
wherein the processor is configured to generate a proposal prompt sentence including control conditions relating to at least one of politeness of a proposal content, a tone of an expression, a number of candidate storage locations to be presented, and a priority of the candidate storage locations, by using, as input information, the past storage history data and an emotion analysis result indicating the user emotional state, and to present the proposal prompt sentence to the generative AI model so as to cause the generative AI model to generate and output a natural-language sentence for proposing the storage location to the user in which the control conditions are reflected.

### Application Example 1

### (Supplementary 1)

A system comprising a processor and a memory storing instructions which, when executed by the processor, cause the processor to:
receive, from an information processing terminal that accepts voice input, audio data including a user inquiry;
control a speech recognition process to convert the audio data into character string data;
receive inquiry data including the character string data from the information processing terminal;
generate a first prompt sentence that instructs a generative AI model or a natural language processing model to analyze the character string data in order to extract structured information for identifying a target item;
input the first prompt sentence and the character string data into the generative AI model or the natural language processing model, and obtain, as the structured information, item identification information for the target item;
execute a search process, based on the item identification information, on a data management apparatus that stores item location information, and obtain location information of the target item from the data management apparatus;
generate a second prompt sentence that instructs the generative AI model to generate a natural language response text based on the obtained location information and the user inquiry;
input the second prompt sentence and the location information into the generative AI model, and obtain the response text in natural language from the generative AI model;
transmit the response text to the information processing terminal so that the information processing terminal presents the response text to the user by at least one of visual display and audio output;
receive, from the information processing terminal, input data including a registration instruction from the user, the registration instruction being expressed by at least one of voice and text and specifying an item and a storage location;
generate a third prompt sentence that instructs the generative AI model to extract, from the input data, structured information including item identification information and storage location information;
input the third prompt sentence and the input data into the generative AI model, and obtain the structured information including the item identification information and the storage location information;
cause the data management apparatus to perform at least one of registration and update of the item location information of the item, based on the structured information;
refer to past storage history information and usage history information related to items that are the same as or similar to the item, and calculate a recommended storage location for the item based on the past storage history information and the usage history information;
generate a fourth prompt sentence that instructs the generative AI model to generate, based on the recommended storage location and the past storage history information, a natural language message including a recommendation and a reason for the recommendation;
input the fourth prompt sentence and data including the recommended storage location into the generative AI model, and obtain the natural language message from the generative AI model;
transmit the natural language message to the information processing terminal so that the information processing terminal presents the recommended storage location to the user;
receive emotion information indicating an emotional state of the user from an emotion recognition processing apparatus; and
adjust at least one of contents of the first to fourth prompt sentences, the response text, and a presentation mode of the recommended storage location based on the emotion information.

### (Supplementary 2)

The system according to supplementary 1,
wherein the processor is configured to cause the data management apparatus to record, as the item location information, data including at least one of information indicating a physical storage place and information indicating a digital storage place, and to search, based on the structured information, at least one of the information indicating the physical storage place and the information indicating the digital storage place, and to generate, for the generative AI model, a prompt sentence that instructs the generative AI model to integrate the information indicating the physical storage place and the information indicating the digital storage place into a unified presentation.

### (Supplementary 3)

The system according to supplementary 1,
wherein the processor is configured to generate, according to context information including past storage location information related to items of a same type, user usage history information, and the emotion information, a prompt sentence that specifies at least one of tone, level of detail, and explanatory content of a recommendation text to be generated by the generative AI model, and to present the recommended storage location to the user by using the recommendation text generated by the generative AI model based on the prompt sentence.

### Example 2

### (Supplementary 1)

A system comprising a processor and a storage device,
wherein the processor is configured to
receive object information obtained from a user via an information processing terminal, and record, in the storage device, location information corresponding to the object information, analyze, by using a natural language processing technique, an inquiry sentence obtained from the user via the information processing terminal, and retrieve from the storage device and provide location information corresponding to the object information,
generate, based on attribute information and description information related to the object information, a prompt sentence to be input to a generative information processing model, and determine classification information of the object information by using computation processing of the generative information processing model,
acquire, from the storage device, storage history information of object information belonging to the same or a similar classification information based on the classification information, and extract and rank candidate storage locations of the object information based on the storage history information,
generate, based on the candidate storage locations and the classification information, a proposal prompt sentence to be input to the generative information processing model, and generate a storage place proposal sentence in a natural language by using computation processing of the generative information processing model,
estimate an emotion state of the user by using an emotion analysis function, analyze the emotion state of the user, and adjust, based on the emotion state, a presentation method of the location information and content or expression of the storage place proposal sentence, and record, in the storage device as storage history information, a storage location selected or input by the user based on the storage place proposal sentence in association with the object information, and reuse the storage history information for extraction of a subsequent candidate storage location and generation of a subsequent prompt sentence.

### (Supplementary 2)

The system according to supplementary 1,
wherein the processor is configured to
generate the prompt sentence by incorporating, into the prompt sentence, structured data including at least a name of the object information, the description information related to the object information, the classification information, the storage history information, and user attribute information, and input the prompt sentence to the generative information processing model to perform the determination of the classification information and generation of the storage place proposal sentence.

### (Supplementary 3)

The system according to supplementary 1,
wherein the processor is configured to
use, as the generative information processing model, an information processing mechanism in which a dialogue generation process and a classification estimation process are executable by a same or cooperative information processing model, generate a prompt sentence including, as inputs, an analysis result of the inquiry sentence, the storage history information, and the emotion state, and generate, based on the prompt sentence, a presentation sentence of the location information and the storage place proposal sentence in an integrated manner.

### Application Example 2

### (Supplementary 1)

A system comprising a processor and a storage device,
wherein the processor is configured to
receive input from a user and, based on the input, store item location information in the storage device, the item location information including information on a storage position for an item,
analyze an inquiry from the user by using a natural language processing technique and, based on the analysis, retrieve corresponding item location information stored in the storage device and provide the retrieved item location information,
receive image information related to the item from a terminal device, perform image recognition processing on the image information to determine classification information of the item, and retrieve past storage history data from the storage device based on the classification information,
generate a prompt sentence for a generative AI model based on the past storage history data so as to cause generation of proposal content regarding a storage place for an item of the same kind, input the prompt sentence into the generative AI model, and obtain the proposal content for the storage place from the generative AI model,
analyze an emotional state of the user by using an emotion analysis mechanism that recognizes the emotional state of the user, and adjust at least one of provision content of the item location information and the proposal content for the storage place based on the emotional state,
generate a prompt sentence for the generative AI model based on the inquiry from the user and the past storage history data so as to cause the generative AI model to generate an answer in natural language, input the prompt sentence into the generative AI model, and obtain the answer from the generative AI model, and
output at least one of the proposal content and the answer to a display device for the user, receive placement result information indicating a placement result of the item from the user, and append the placement result information to the past storage history data in the storage device.

### (Supplementary 2)

The system according to supplementary 1,
wherein the processor is configured to
manage the item location information stored in the storage device as location information data including a physical storage place and a digital storage place.

### (Supplementary 3)

The system according to supplementary 1,
wherein the processor is configured to
create, in generating the prompt sentence, a prompt sentence that instructs operation of the generative AI model so that at least one of the proposal content for the storage place and the answer in natural language is generated based on the past storage history data and the emotional state of the user, and obtain at least one of the proposal content for the storage place and the answer based on the prompt sentence.

What is claimed is:

1. A system comprising:
circuitry configured to:
receive, via a communication interface coupled to a packet-switched network, item identification information and storage location information from a terminal device, and store the item identification information and the storage location information as location information in a database management program operating on an information processing apparatus;
generate a prompt sentence for a generative AI model incorporating an analysis of an inquiry from a user received via the communication interface and the stored location information, input the prompt sentence to the generative AI model, and obtain a natural language response including location information of the queried item; and
analyze an emotional state of the user using an emotion analysis engine based on data received from the terminal device via the communication interface, adjust provision of the location information and any storage location suggestions based on the emotional state, and transmit the response to the terminal device via the communication interface.

2. The system according to claim 1, wherein the circuitry is configured to receive item identification information and storage location information from the terminal device via the communication interface, and store the item identification information and the storage location information as an association between an item and a storage location in the database.

3. The system according to claim 2, wherein the circuitry is configured to store the location information in the database including at least one of a physical location and a digital storage location in association with an item identifier.

4. The system according to claim 1, wherein the circuitry is configured to receive an inquiry from the terminal device via the communication interface, apply a natural language processing technique to analyze the inquiry to extract an item identifier and a query intent, and search the database for location information matching the extracted item identifier.

5. The system according to claim 4, wherein the circuitry is configured to generate the prompt sentence incorporating the extracted item identifier, the query intent, and the retrieved location information, and input the prompt sentence to the generative AI model to obtain a natural language response describing the location of the queried item.

6. The system according to claim 1, wherein the circuitry is configured to refer to past storage history data stored in the storage device to identify items belonging to the same type as another item, generate a prompt sentence instructing the generative AI model to suggest a storage location for the item based on the past storage history, and transmit the suggestion to the terminal device.

7. The system according to claim 6, wherein the circuitry is configured to update the past storage history data based on new storage location information received from the terminal device via the communication interface, and use the updated history data for subsequent storage location suggestions.

8. The system according to claim 1, wherein the circuitry is configured to analyze the emotional state of the user by applying the emotion analysis engine to at least one of text data, vocal characteristics, and behavioral patterns in data received from the terminal device via the communication interface.

9. The system according to claim 8, wherein the circuitry is configured to adjust at least one of a response format, a content detail level, and a presentation style of the location information and storage suggestions based on the analyzed emotional state.

10. The system according to claim 1, wherein the circuitry is configured to receive, from the terminal device via the communication interface, a notification that an item has been moved to a new storage location, update the location information in the database accordingly, and confirm the update to the terminal device.

11. The system according to claim 10, wherein the circuitry is configured to detect inconsistencies between the stored location information and movement notifications received from the terminal device, flag the inconsistencies, and generate a prompt sentence for the generative AI model to recommend resolution of the inconsistencies.

12. The system according to claim 1, wherein the circuitry is configured to receive, from the terminal device, a query for a plurality of items via the communication interface, retrieve location information for each queried item from the database, and generate a consolidated natural language response incorporating location information for all queried items.

13. The system according to claim 12, wherein the circuitry is configured to generate the consolidated response by inputting a prompt sentence incorporating location information for all queried items to the generative AI model, and obtain a natural language summary for transmission to the terminal device.

14. The system according to claim 1, wherein the circuitry is configured to store usage frequency data for each item in the database based on query history received from the terminal device via the communication interface, and use the usage frequency data to generate storage optimization suggestions.

15. The system according to claim 14, wherein the circuitry is configured to generate a prompt sentence for the generative AI model incorporating the usage frequency data and current storage location assignments, and obtain from the generative AI model a storage reorganization recommendation for transmission to the terminal device.

16. The system according to claim 1, wherein the circuitry is configured to receive, from the terminal device, image data representing a storage environment, extract item identifiers and location information from the image data, and update the database with the extracted information.

17. The system according to claim 16, wherein the circuitry is configured to detect discrepancies between location information extracted from the image data and location information stored in the database, and generate a prompt sentence for the generative AI model to resolve the discrepancies.

18. A system comprising:
circuitry configured to:
receive, via a communication interface coupled to a packet-switched network, item identification information and storage location information from a terminal device, and store the information as location data in a database;
receive an inquiry from the terminal device via the communication interface, apply natural language processing to analyze the inquiry, retrieve matching location information from the database, and generate a prompt sentence for a generative AI model incorporating the location information;
input the prompt sentence to the generative AI model to obtain a natural language response, analyze an emotional state of the user using an emotion analysis engine, and adjust the response based on the emotional state; and
transmit the adjusted response to the terminal device via the communication interface, and update the database based on storage location changes received from the terminal device.

19. The system according to claim 18, wherein the circuitry is configured to refer to past storage history data to generate storage location suggestions for items of the same type, generate a prompt sentence for the generative AI model incorporating the storage history data, and transmit the suggestions to the terminal device via the communication interface.

20. A method comprising:
receiving, via a communication interface coupled to a packet-switched network, item identification information and storage location information from a terminal device, and storing the item identification information and the storage location information as location information in a database;
generating a prompt sentence for a generative AI model incorporating an analysis of an inquiry from a user and the stored location information, inputting the prompt sentence to the generative AI model, and obtaining a natural language response; and
analyzing an emotional state of the user using an emotion analysis engine, adjusting the response based on the emotional state, and transmitting the response to the terminal device via the communication interface.
